(19) United States
(12) Patent Application Publication
(10) Pub. No.: US 2021/0157336 A1
(43) Pub. Date: May 27, 2021

(54) UNMANNED AERIAL VEHICLE AND STATION

(71) Applicant: LG ELECTRONICS INC., Seoul (KR)

(72) Inventors: Pilwon KWAK, Seoul (KR); Jeongkyo SEO, Seoul (KR)

(21) Appl. No.: 17/105,788

(22) Filed: Nov. 27, 2020

(30) Foreign Application Priority Data
Nov. 26, 2019 (KR) 10-2019-0153336

(51) Int. Cl. G05D 1/06; G05D 1/00; B64F 1/20; B64C 39/02

(52) U.S. Cl. CPC G05D 1/0676; G05D 1/0094; B64F 1/20; B64C 2201/14; B64C 2201/108; B64C 2201/18; B64C 39/024

(57) ABSTRACT

According to an embodiment of the present invention, an unmanned aerial vehicle (UAV) may recognize at least some of light output from light sources of a station, and determine a current location based on the recognized light. At least one of the unmanned aerial vehicle and the station according to an embodiment of the present invention may be linked to an Artificial Intelligence module, a robot, a device related to a 5G service, and the like.

### CROSS-REFERENCE TO RELATED APPLICATION(S)

This application claims the priority benefit of Korean Patent Application No. 10-2019-0153336, filed on Nov. 26, 2019 in the Korean Intellectual Property Office, the disclosure of which is incorporated herein by reference.

### BACKGROUND

### 1. Field

The present invention relates to an unmanned aerial vehicle and a station, and more particularly to technology of an unmanned aerial vehicle and a station determining or learning a map or recognizing a location on the map.

### 2. Background

An unmanned aerial vehicle generally refers to an aircraft and a helicopter-shaped unmanned aerial vehicle/uninhabited aerial vehicle (UAV) capable of a flight and pilot by the induction of a radio wave without a pilot. A recent unmanned aerial vehicle is increasingly used in various civilian and commercial fields, such as image photographing, unmanned delivery service, and disaster observation, in addition to military use such as reconnaissance and an attack.

As an operation method of such unmanned aerial vehicle, it can be operated through an unmanned aerial control system including a vehicle that is remotely piloted from the ground, autonomously flies in an automatic or semi-auto-piloted format according to a pre-programmed route, or performs missions according to its own environmental judgment by mounting artificial intelligence, Ground Control Station/System(GCS) and communication(data link) support equipments.

### BRIEF DESCRIPTION OF THE DRAWINGS

The embodiments will be described in detail with reference to the following drawings in which like reference numerals refer to like elements wherein:

The above and other objects, features and other advantages of the present invention will be more clearly understood from the following detailed description taken in conjunction with the accompanying drawings, in which:

FIG. 1 shows a perspective view of an unmanned aerial vehicle to which a method proposed in the specification is applicable.

FIG. 2 is a block diagram showing a control relation between major elements of the unmanned aerial vehicle of FIG. 1.

FIG. 3 is a block diagram showing a control relation between major elements of an aerial control system according to an embodiment of the present invention.

FIG. 4 illustrates a block diagram of a wireless communication system to which methods proposed in the specification are applicable.

FIG. 5 is a diagram showing an example of a signal transmission/reception method in a wireless communication system.

FIG. 6 shows an example of a basic operation of a robot and a 5G network in a 5G communication system.

FIG. 7 illustrates an example of a basic operation between robots using 5G communication.

FIG. 8 is a diagram showing an example of the concept diagram of a 3GPP system including a UAS.

FIG. 9 shows examples of a C2 communication model for a UAV.

FIG. 10 is a flowchart showing an example of a measurement execution method to which the present invention is applicable.

FIG. 11 is a block diagram showing a control relationship between main components of an aerial control system according to the embodiment of the present invention.

FIG. 12 shows examples of an arrangement of a light source according to embodiments of the present invention.

FIG. 13 is a diagram referenced illustrating optical recognition according to the embodiment of the present invention.

FIG. 14 shows an example of an arrangement of a light reception module according to embodiments of the present invention.

FIG. 15 is a flowchart showing a location control method according to the embodiment of the present invention.

FIG. 16 is a diagram referenced illustrating a location control method according to the embodiment of the present invention.

FIG. 17 is a flowchart showing a location control method according to the embodiment of the present invention.

FIG. 18 is a diagram referenced illustrating a location control method according to the embodiment of the present invention.

FIGS. 19a and 19b are diagrams referenced illustrating a location control method according to the embodiment of the present invention.

FIG. 20 is a diagram referenced illustrating an aerial control system according to the embodiment of the present invention.

FIGS. 21 and 22 are diagrams referenced illustrating location control method according to the embodiment of the present invention.

FIG. 23 is a diagram referenced illustrating an altitude determination method according to the embodiment of the present invention.

FIG. 24 shows a block diagram of a wireless communication device according to an embodiment of the present invention.

FIG. 25 is a block diagram of a communication device according to an embodiment of the present invention.

### DETAILED DESCRIPTION

Reference will now be made in detail to embodiments, examples of which are illustrated in the accompanying drawings. However, the present invention may be embodied in many different forms and should not be construed as being limited to the embodiments set forth herein.

Meanwhile, in the following description, with respect to constituent elements used in the following description, the suffixes “module” and “unit” are used or combined with each other only in consideration of ease in preparation of the specification, and do not have or indicate mutually different meanings. Accordingly, the suffixes “module” and “unit” may be used interchangeably.

Also, it will be understood that although the terms “first,” “second,” etc., may be used herein to describe various components, these components should not be limited by these terms. These terms are only used to distinguish one component from another component.

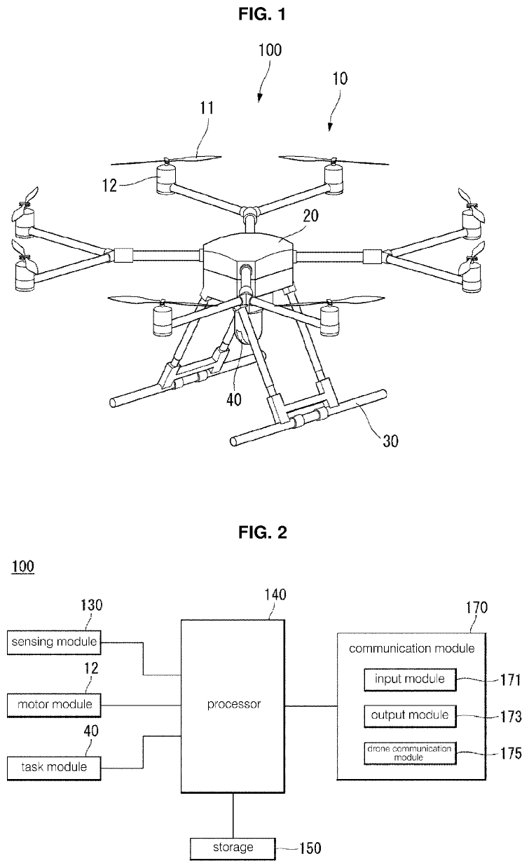

FIG. 1 shows a perspective view of an unmanned aerial vehicle to which a method proposed in the specification is applicable.

FIG. 1 shows a perspective view of an unmanned aerial vehicle according to an embodiment of the present invention.

First, the unmanned aerial vehicle 100 is manually manipulated by an administrator on the ground, or it flies in an unmanned manner while it is automatically piloted by a configured flight program. The unmanned aerial vehicle 100, as in FIG. 1, includes a main body 20, a horizontal and vertical movement propulsion device 10, and landing legs 130.

The main body 20 is a body portion on which a module, such as a task module 40, is mounted.

The unmanned aerial vehicle 100 may include a task module 40 that performs a predetermined task.

As an example, the task module 40 may be provided to perform a photographing operation with a camera for photographing an image.

As another example, the task module 40 may be equipped with equipment to assist in precise construction at a construction site. For example, the task module 40 may include a laser for a guide at a construction site, a camera for monitoring a construction site, and the like.

As another example, the task module 40 may be provided to perform a transport operation of objects and people.

As another example, the task module 40 may perform a security function that detects an external intruder or a dangerous situation. The task module 40 may be equipped with a camera for performing such a security function.

There may be various examples of the types of work of the task module 40, and there is no need to be limited to the examples of this description. In addition, the unmanned aerial vehicle 100 may perform a plurality of tasks, and the task module 40 may be provided with modules and equipment for a plurality of tasks performed by the unmanned aerial vehicle 100.

The horizontal and vertical movement propulsion device 10 includes one or more propellers 11 positioned vertically to the main body 20. The horizontal and vertical movement propulsion device 10 according to an embodiment of the present invention includes a plurality of propellers 11 and motors 12, which are spaced apart. In this case, the horizontal and vertical movement propulsion device 10 may have an air jet propeller structure not the propeller 11.

A plurality of propeller supports is radially formed in the main body 20. The motor 12 may be mounted on each of the propeller supports. The propeller 11 is mounted on each motor 12.

The plurality of propellers 11 may be disposed symmetrically with respect to the main body 20. Furthermore, the rotation direction of the motor 12 may be determined so that the clockwise and counterclockwise rotation directions of the plurality of propellers 11 are combined. The rotation direction of one pair of the propellers 11 symmetrical with respect to the main body 20 may be set identically (e.g., clockwise). Furthermore, the other pair of the propellers 11 may have a rotation direction opposite (e.g., counterclockwise) that of the one pair of the propellers 11.

The landing legs 30 are disposed with being spaced apart at the bottom of the main body 20. Furthermore, a buffering support member (not shown) for minimizing an impact attributable to a collision with the ground when the unmanned aerial vehicle 100 makes a landing may be mounted on the bottom of the landing leg 30.

The unmanned aerial vehicle 100 may have various aerial vehicle structures different from that described above.

FIG. 2 is a block diagram showing a control relation between major elements of the unmanned aerial vehicle of FIG. 1.

Referring to FIG. 2, the unmanned aerial vehicle 100 measures its own flight state using a variety of types of sensors in order to fly stably.

The unmanned aerial vehicle 100 may include a sensing module 130 including at least one sensor.

The flight state of the unmanned aerial vehicle 100 is defined as rotational states and translational states.

The rotational states mean “yaw”, “pitch”, and “roll.” The translational states mean longitude, latitude, altitude, and velocity.

In this case, “roll”, “pitch”, and “yaw” are called Euler angle, and indicate that the x, y, z three axes of an aircraft body frame coordinate have been rotated with respect to a given specific coordinate, for example, three axes of NED coordinates N, E, D. If the front of an aircraft is rotated left and right on the basis of the z axis of a body frame coordinate, the x axis of the body frame coordinate has an angle difference with the N axis of the NED coordinate, and this angle is called “yaw” (ψ). If the front of an aircraft is rotated up and down on the basis of the y axis toward the right, the z axis of the body frame coordinate has an angle difference with the D axis of the NED coordinates, and this angle is called a “pitch” (θ). If the body frame of an aircraft is inclined left and right on the basis of the x axis toward the front, the y axis of the body frame coordinate has an angle to the E axis of the NED coordinates, and this angle is called “roll” (ϕ)).

The unmanned aerial vehicle 100 uses 3-axis gyroscopes, 3-axis accelerometers, and 3-axis magnetometers in order to measure the rotational states, and uses a GPS sensor and a barometric pressure sensor in order to measure the translational states.

The sensing module 130 of the present invention includes at least one of the gyroscopes, the accelerometers, the GPS sensor, the image sensor or the barometric pressure sensor. In this case, the gyroscopes and the accelerometers measure the states in which the body frame coordinates of the unmanned aerial vehicle 100 have been rotated and accelerated with respect to earth centered inertial coordinate. The gyroscopes and the accelerometers may be fabricated as a single chip called an inertial measurement module (IMU) using a micro-electro-mechanical systems (MEMS) semiconductor process technology.

Furthermore, the IMU chip may include a microcontroller for converting measurement values based on the earth centered inertial coordinates, measured by the gyroscopes and the accelerometers, into local coordinates, for example, north-east-down (NED) coordinates used by GPSs.

The gyroscopes measure angular velocity at which the body frame coordinate x, y, z three axes of the unmanned aerial vehicle 100 rotate with respect to the earth centered inertial coordinates, calculate values (Wx.gyro, Wy.gyro, Wz.gyro) converted into fixed coordinates, and convert the values into Euler angles (ϕgyro, ϕgyro, ψgyro) using a linear differential equation.

The accelerometers measure acceleration for the earth centered inertial coordinates of the body frame coordinate x, y, z three axes of the unmanned aerial vehicle 100, calculate values (fx,acc, fy,acc, fz,acc) converted into fixed coordinates, and convert the values into “roll (ϕacc)” and “pitch (θacc).” The values are used to remove a bias error included in “roll (ϕgyro)” and “pitch (θgyro)” using measurement values of the gyroscopes.

The magnetometers measure the direction of magnetic north points of the body frame coordinate x, y, z three axes of the unmanned aerial vehicle 100, and calculate a “yaw” value for the NED coordinates of body frame coordinates using the value.

The GPS sensor calculates the translational states of the unmanned aerial vehicle 100 on the NED coordinates, that is, a latitude (Pn.GPS), a longitude (Pe.GPS), an altitude (hMSL.GPS), velocity (Vn.GPS) on the latitude, velocity (Ve.GPS) on longitude, and velocity (Vd.GPS) on the altitude, using signals received from GPS satellites. In this case, the subscript MSL means a mean sea level (MSL).

The barometric pressure sensor may measure the altitude (hALP.baro) of the unmanned aerial vehicle 100. In this case, the subscript ALP means an air-level pressor. The barometric pressure sensor calculates a current altitude from a take-off point by comparing an air-level pressor when the unmanned aerial vehicle 100 takes off with an air-level pressor at a current flight altitude.

The camera sensor may include an image sensor (e.g., CMOS image sensor), including at least one optical lens and multiple photodiodes (e.g., pixels) on which an image is focused by light passing through the optical lens, and a digital signal processor (DSP) configuring an image based on signals output by the photodiodes. The DSP may generate a moving image including frames configured with a still image, in addition to a still image.

The unmanned aerial vehicle 100 includes a communication module 170 for inputting or receiving information or outputting or transmitting information. The communication module 170 may include a drone communication module 175 for transmitting/receiving information to/from a different external device. The communication module 170 may include an input module 171 for inputting information. The communication module 170 may include an output module 173 for outputting information.

The output module 173 may be omitted from the unmanned aerial vehicle 100, and may be formed in a terminal 300.

For example, the unmanned aerial vehicle 100 may directly receive information from the input module 171. For another example, the unmanned aerial vehicle 100 may receive information, input to a separate terminal 300 or server 200, through the drone communication module 175.

For example, the unmanned aerial vehicle 100 may directly output information to the output module 173. For another example, the unmanned aerial vehicle 100 may transmit information to a separate terminal 300 through the drone communication module 175 so that the terminal 300 outputs the information.

The drone communication module 175 may be provided to communicate with an external server 200, an external terminal 300, etc. The drone communication module 175 may receive information input from the terminal 300, such as a smartphone or a computer. The drone communication module 175 may transmit information to be transmitted to the terminal 300. The terminal 300 may output information received from the drone communication module 175.

The drone communication module 175 may receive various command signals from the terminal 300 or/and the server 200. The drone communication module 175 may receive area information for driving, a driving route, or a driving command from the terminal 300 or/and the server 200. In this case, the area information may include flight restriction area (A) information and approach restriction distance information.

The input module 171 may receive On/Off or various commands. The input module 171 may receive area information. The input module 171 may receive object information. The input module 171 may include various buttons or a touch pad or a microphone.

The output module 173 may notify a user of various pieces of information. The output module 173 may include a speaker and/or a display. The output module 173 may output information on a discovery detected while driving. The output module 173 may output identification information of a discovery. The output module 173 may output location information of a discovery.

The unmanned aerial vehicle 100 includes a processor 140 for processing and determining various pieces of information, such as mapping and/or a current location. The processor 140 may control an overall operation of the unmanned aerial vehicle 100 through control of various elements that configure the unmanned aerial vehicle 100.

The processor 140 may receive information from the communication module 170 and process the information. The processor 140 may receive information from the input module 171, and may process the information. The processor 140 may receive information from the drone communication module 175, and may process the information.

The processor 140 may receive sensing information from the sensing module 130, and may process the sensing information.

The processor 140 may control the driving of the motor module 12. The motor module 12 may each include one or more motors and other components necessary for driving the motor.

The processor 140 may control the operation of the task module 40.

The unmanned aerial vehicle 100 includes a storage 150 for storing various data. The storage 150 records various pieces of information necessary for control of the unmanned aerial vehicle 100, and may include a volatile or non-volatile recording medium.

A map for a driving area may be stored in the storage 150. The map may have been input by the external terminal 300 capable of exchanging information with the unmanned aerial vehicle 100 through the drone communication module 175, or may have been autonomously learnt and generated by the unmanned aerial vehicle 100. In the former case, the external terminal 300 may include a remote controller, a PDA, a laptop, a smartphone or a tablet on which an application for a map configuration has been mounted, for example.

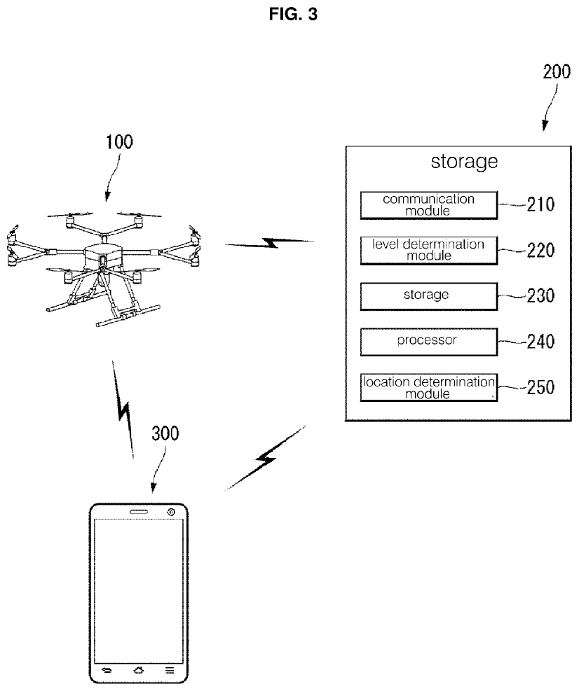

FIG. 3 is a block diagram showing a control relation between major elements of an aerial control system according to an embodiment of the present invention.

Referring to FIG. 3, the aerial control system according to an embodiment of the present invention may include the unmanned aerial vehicle 100 and the server 200, or may include the unmanned aerial vehicle 100, the terminal 300, and the server 200.

The terminal 300 may include a controller that receives a control command for controlling the unmanned aerial vehicle 100 and an output unit that outputs visual or auditory information.

The server 200 stores information on the restricted flight area in which flight of the unmanned aerial vehicle 100 is restricted, calculates the access restriction distance of the restricted flight area differently according to the autonomous driving level of the unmanned aerial vehicle 100, and provides information on a restricted flight area and information on a restricted access distance to at least one of the unmanned aerial vehicle 100 and the terminal 300. Therefore, in the case of the unmanned aerial vehicle 100 having a high autonomous driving level, an efficient route is driven, and in the case of the unmanned vehicle 100 having a low autonomous driving level, the unmanned aerial vehicle 100 having a low level of autonomous driving is close to the flight restriction area. There is an advantage that can prevent accidents that may occur.

In addition, the server 200 may set a flight path based on the flight restriction area information and the access restriction distance information, and provide the flight route to at least one of the unmanned aerial vehicle 100 and the terminal 300.

Actively, the server 200 may set a flight path based on the flight restriction area information and the access restriction distance information according to the autonomous driving level, and control the unmanned aerial vehicle 100 according to the flight route.

When the unmanned aerial vehicle 100 approaches within the restricted access distance, the server 200 may transmit different commands to the unmanned aerial vehicle 100 according to the autonomous driving level. The server 200 may transmit different commands to the unmanned aerial vehicle 100 whether automatic or manual adjustment of the unmanned aerial vehicle 100 is performed.

For example, the server 200 may include a communication module 210 that exchanges information with the unmanned aerial vehicle 100 and/or the terminal 300, a level determination module 220 that determines the autonomous driving level of the unmanned aerial vehicle 100, a storage 230 that stores information on the restricted flight area in which flight of the unmanned aerial vehicle 100 is restricted, and a processor 240 that provides information to the unmanned aerial vehicle 100 and/or a terminal 300 or controls the unmanned aerial vehicle 100 and/or the terminal 300. In addition, the server 200 may further include a location determination module 250 that determines the location and altitude of the unmanned aerial vehicle 100 through the location and altitude information provided from the unmanned aerial vehicle 100.

The storage 230 may store information on the unmanned aerial vehicle 100 and/or the terminal 200. In addition, the port storage 230 stores information on the restricted flight area for public control, stores information on the autonomous driving level of the unmanned aerial vehicle 100, and provides information on air control of the unmanned aerial vehicle 100 Can be saved.

The level determination module 220 determines the autonomous driving level of the unmanned aerial vehicle 100. The autonomous driving level of the unmanned aerial vehicle 100 is determined through autonomous driving level information transmitted from the unmanned aerial vehicle 100 to the server 200 or through autonomous driving level information provided from the terminal 300.

The autonomous driving level of the unmanned aerial vehicle 100 is defined as level 1, which is the level of fully manual driving only, or the level of assisting manual driving with various sensors. And the autonomous driving level of the unmanned aerial vehicle 100 is defined as level 2, which is the level of the unmanned aerial vehicle 100 is semi-autonomous driving (automatic take-off and landing, passive obstacle avoidance, moving according to the route specified by the user). And level 3 is the level at which the unmanned aerial vehicle 100 is completely autonomous (creating a route by itself, moving to the destination (S2), and performing tasks by itself).

The processor 240 calculates the access restriction distance of the flight restricted area differently according to the autonomous driving level of the unmanned aerial vehicle 100, and provides the flight restriction area information and the access restriction distance information to the unmanned aerial vehicle 100 and/or the terminal 300.

The information on the restricted flight area may include location information of the restricted flight area and boundary information of the restricted flight area.

The processor 240 may transmit different commands to the unmanned aerial vehicle 100 according to the autonomous driving level when the unmanned aerial vehicle 100 approaches within the restricted access distance. Accordingly, it is possible to induce efficient driving in the flight restricted area and prevent accidents according to the autonomous driving level.

The unmanned aerial vehicle 100, the terminal 300, and the server 200 are interconnected using a wireless communication method.

Global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), etc. may be used as the wireless communication method.

A wireless Internet technology may be used as the wireless communication method. The wireless Internet technology includes a wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and 5G, for example. In particular, a faster response is possible by transmitting/receiving data using a 5G communication network.

In the specification, a base station has a meaning as a terminal node of a network that directly performs communication with a terminal. In the specification, a specific operation illustrated as being performed by a base station may be performed by an upper node of the base station in some cases. That is, it is evident that in a network configured with a plurality of network nodes including a base station, various operations performed for communication with a terminal may be performed by the base station or different network nodes other than the base station. A “base station (BS)” may be substituted with a term, such as a fixed station, a Node B, an evolved-NodeB (eNB), a base transceiver system (BTS), an access point (AP), or a next generation NodeB (gNB). Furthermore, a “terminal” may be fixed or may have mobility, and may be substituted with a term, such as a user equipment (UE), a mobile station (MS), a user terminal (UT), a mobile subscriber station (MSS), a subscriber station (SS), an advanced mobile station (AMS), a wireless terminal (WT), a machine-type communication (MTC) device, a machine-to-machine (M2M) device, or a device-to-device (D2D) device.

Hereinafter, downlink (DL) means communication from a base station to a terminal. Uplink (UL) means communication from a terminal to a base station. In the downlink, a transmitter may be part of a base station, and a receiver may be part of a terminal. In the uplink, a transmitter may be part of a terminal, and a receiver may be part of a base station.

Specific terms used in the following description have been provided to help understanding of the present invention. The use of such a specific term may be changed into another form without departing from the technical spirit of the present invention.

Embodiments of the present invention may be supported by standard documents disclosed in at least one of IEEE 802, 3GPP and 3GPP2, that is, radio access systems. That is, steps or portions not described in order not to clearly disclose the technical spirit of the present invention in the embodiments of the present invention may be supported by the documents. Furthermore, all terms disclosed in this document may be described by the standard documents.

In order to clarity the description, 3GPP 5G is chiefly described, but the technical characteristic of the present invention is not limited thereto.

UE and 5G Network Block Diagram Example

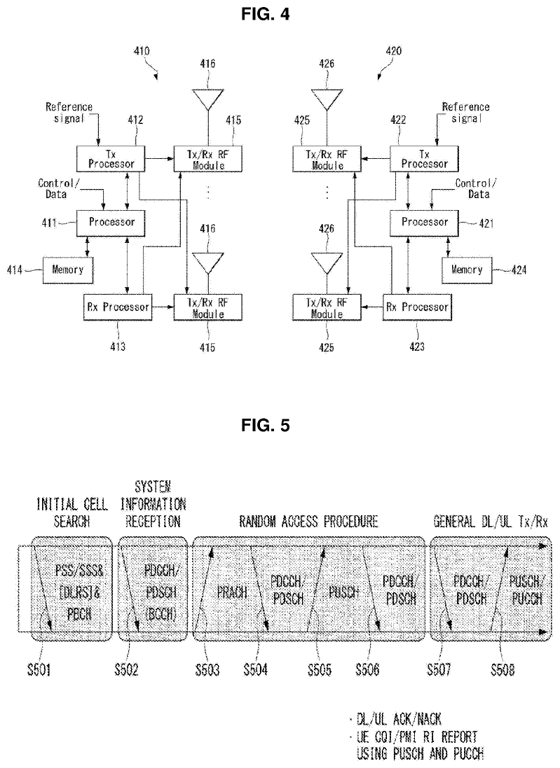

FIG. 4 illustrates a block diagram of a wireless communication system to which methods proposed in the specification are applicable.

Referring to FIG. 4, a drone is defined as a first communication device (410 of FIG. 4). A processor 411 may perform a detailed operation of the unmanned aerial vehicle.

The unmanned aerial vehicle e may be represented as a drone or an unmanned aerial robot.

A 5G network communicating with a drone may be defined as a second communication device (420 of FIG. 4). A processor 421 may perform a detailed operation of the drone. In this case, the 5G network may include another drone communicating with the drone.

A 5G network maybe represented as a first communication device, and a drone may be represented as a second communication device.

For example, the first communication device or the second communication device may be a base station, a network node, a transmission terminal, a reception terminal, a wireless apparatus, a wireless communication device or a drone.

For example, a terminal or a user equipment (UE) may include a drone, an unmanned aerial vehicle (UAV), a mobile phone, a smartphone, a laptop computer, a terminal for digital broadcasting, personal digital assistants (PDA), a portable multimedia player (PMP), a navigator, a slate PC, a tablet PC, an ultrabook, a wearable device (e.g., a watch type terminal (smartwatch), a glass type terminal (smart glass), and a head mounted display (HMD). For example, the HMD may be a display device of a form, which is worn on the head. For example, the HMD may be used to implement VR, AR or MR. Referring to FIG. 4, the first communication device 410, the second communication device 420 includes a processor 411, 421, a memory 414, 424, one or more Tx/Rx radio frequency (RF) modules 415, 425, a Tx processor 412, 422, an Rx processor 413, 423, and an antenna 416, 426. The Tx/Rx module is also called a transceiver. Each Tx/Rx module 415 transmits a signal each antenna 426. The processor implements the above-described function, process and/or method. The processor 421 may be related to the memory 424 for storing a program code and data. The memory may be referred to as a computer-readable recording medium. More specifically, in the DL (communication from the first communication device to the second communication device), the transmission (TX) processor 912 implements various signal processing functions for the L1 layer (i.e., physical layer). The reception (RX) processor implements various signal processing functions for the L1 layer (i.e., physical layer).

UL (communication from the second communication device to the first communication device) is processed by the first communication device 410 using a method similar to that described in relation to a receiver function in the second communication device 420. Each Tx/Rx module 425 receives a signal through each antenna 426. Each Tx/Rx module provides an RF carrier and information to the RX processor 923. The processor 421 may be related to the memory 424 for storing a program code and data. The memory may be referred to as a computer-readable recording medium.

Signal Transmission/Reception Method in Wireless Communication System

FIG. 5 is a diagram showing an example of a signal transmission/reception method in a wireless communication system.

FIG. 5 shows the physical channels and general signal transmission used in a 3GPP system. In the wireless communication system, the terminal receives information from the base station through the downlink (DL), and the terminal transmits information to the base station through the uplink (UL). The information which is transmitted and received between the base station and the terminal includes data and various control information, and various physical channels exist according to a type/usage of the information transmitted and received therebetween.

When power is turned on or the terminal enters a new cell, the terminal performs initial cell search operation such as synchronizing with the base station (S201). To this end, the terminal may receive a primary synchronization signal (PSS) and a secondary synchronization signal (SSS) from the base station to synchronize with the base station and obtain information such as a cell ID. Thereafter, the terminal may receive a physical broadcast channel (PBCH) from the base station to obtain broadcast information in a cell. Meanwhile, the terminal may check a downlink channel state by receiving a downlink reference signal (DL RS) in an initial cell search step.

After the terminal completes the initial cell search, the terminal may obtain more specific system information by receiving a physical downlink control channel (PDSCH) according to a physical downlink control channel (PDCCH) and information on the PDCCH (S202).

When the terminal firstly connects to the base station or there is no radio resource for signal transmission, the terminal may perform a random access procedure (RACH) for the base station (S203 to S206). To this end, the terminal may transmit a specific sequence to a preamble through a physical random access channel (PRACH) (S203 and S205), and receive a response message (RAR (Random Access Response) message) for the preamble through the PDCCH and the corresponding PDSCH. In case of a contention-based RACH, a contention resolution procedure may be additionally performed (S206).

After the terminal performs the procedure as described above, as a general uplink/downlink signal transmission procedure, the terminal may perform a PDCCH/PDSCH reception (S207) and physical uplink shared channel (PUSCH)/physical uplink control channel (PUCCH) transmission (S208). In particular, the terminal may receive downlink control information (DCI) through the PDCCH. Here, the DCI includes control information such as resource allocation information for the terminal, and the format may be applied differently according to a purpose of use.

Meanwhile, the control information transmitted by the terminal to the base station through the uplink or received by the terminal from the base station may include a downlink/uplink ACK/NACK signal, a channel quality indicator (CQI), a precoding matrix index (PMI), and a rank indicator (RI), or the like. The terminal may transmit the above-described control information such as CQI/PMI/RI through PUSCH and/or PUCCH.

An initial access (IA) procedure in a 5G communication system is additionally described with reference to FIG. 5.

A UE may perform cell search, system information acquisition, beam alignment for initial access, DL measurement, etc. based on an SSB. The SSB is interchangeably used with a synchronization signal/physical broadcast channel (SS/PBCH) block.

An SSB is configured with a PSS, an SSS and a PBCH. The SSB is configured with four contiguous OFDM symbols. A PSS, a PBCH, an SSS/PBCH or a PBCH is transmitted for each OFDM symbol. Each of the PSS and the SSS is configured with one OFDM symbol and 127 subcarriers. The PBCH is configured with three OFDM symbols and 576 subcarriers.

Cell search means a process of obtaining, by a UE, the time/frequency synchronization of a cell and detecting the cell identifier (ID) (e.g., physical layer cell ID (PCI)) of the cell. A PSS is used to detect a cell ID within a cell ID group. An SSS is used to detect a cell ID group. A PBCH is used for SSB (time) index detection and half-frame detection.

There are 336 cell ID groups. 3 cell IDs are present for each cell ID group. A total of 1008 cell IDs are present. Information on a cell ID group to which the cell ID of a cell belongs is provided/obtained through the SSS of the cell. Information on a cell ID among the 336 cells within the cell ID is provided/obtained through a PSS.

An SSB is periodically transmitted based on SSB periodicity. Upon performing initial cell search, SSB base periodicity assumed by a UE is defined as 20 ms. After cell access, SSB periodicity may be set as one of {5 ms, 10 ms, 20 ms, 40 ms, 80 ms, 160 ms} by a network (e.g., BS).

Next, system information (SI) acquisition is described.

SI is divided into a master information block (MIB) and a plurality of system information blocks (SIBs). SI other than the MIB may be called remaining minimum system information (RMSI). The MIB includes information/parameter for the monitoring of a PDCCH that schedules a PDSCH carrying SystemInformationBlock1 (SIB1), and is transmitted by a BS through the PBCH of an SSB. SIB1 includes information related to the availability of the remaining SIBs (hereafter, SIBx, x is an integer of 2 or more) and scheduling (e.g., transmission periodicity, SI-window size). SIBx includes an SI message, and is transmitted through a PDSCH. Each SI message is transmitted within a periodically occurring time window (i.e., SI-window).

A random access (RA) process in a 5G communication system is additionally described with reference to FIG. 5.

A random access process is used for various purposes. For example, a random access process may be used for network initial access, handover, UE-triggered UL data transmission. A UE may obtain UL synchronization and an UL transmission resource through a random access process. The random access process is divided into a contention-based random access process and a contention-free random access process. A detailed procedure for the contention-based random access process is described below.

A UE may transmit a random access preamble through a PRACH as Msg1 of a random access process in the UL. Random access preamble sequences having two different lengths are supported. A long sequence length 839 is applied to subcarrier spacings of 1.25 and 5 kHz, and a short sequence length 139 is applied to subcarrier spacings of 15, 30, 60 and 120 kHz.

When a BS receives the random access preamble from the UE, the BS transmits a random access response (RAR) message (Msg2) to the UE. A PDCCH that schedules a PDSCH carrying an RAR is CRC masked with a random access (RA) radio network temporary identifier (RNTI) (RA-RNTI), and is transmitted. The UE that has detected the PDCCH masked with the RA-RNTI may receive the RAR from the PDSCH scheduled by DCI carried by the PDCCH. The UE identifies whether random access response information for the preamble transmitted by the UE, that is, Msg1, is present within the RAR. Whether random access information for Msg1 transmitted by the UE is present may be determined by determining whether a random access preamble ID for the preamble transmitted by the UE is present. If a response for Msg1 is not present, the UE may retransmit an RACH preamble within a given number, while performing power ramping. The UE calculates PRACH transmission power for the retransmission of the preamble based on the most recent pathloss and a power ramping counter.

The UE may transmit UL transmission as Msg3 of the random access process on an uplink shared channel based on random access response information. Msg3 may include an RRC connection request and a UE identity. As a response to the Msg3, a network may transmit Msg4, which may be treated as a contention resolution message on the DL. The UE may enter an RRC connected state by receiving the Msg4.

Beam Management (BM) Procedure of 5G Communication System

A BM process may be divided into (1) a DL BM process using an SSB or CSI-RS and (2) an UL BM process using a sounding reference signal (SRS). Furthermore, each BM process may include Tx beam sweeping configured to determine a Tx beam and Rx beam sweeping configured to determine an Rx beam.

A DL BM process using an SSB is described.

The configuration of beam reporting using an SSB is performed when a channel state information (CSI)/beam configuration is performed in RRC_CONNECTED.

A UE receives, from a BS, a CSI-ResourceConfig IE including CSI-SSB-ResourceSetList for SSB resources used for BM. RRC parameter csi-SSB-ResourceSetList indicates a list of SSB resources used for beam management and reporting in one resource set. In this case, the SSB resource set may be configured with {SSBx1, SSBx2, SSBx3, SSBx4, . . . }. SSB indices may be defined from 0 to 63.

The UE receives signals on the SSB resources from the BS based on the CSI-SSB-ResourceSetList.

If SSBRI and CSI-RS reportConfig related to the reporting of reference signal received power (RSRP) have been configured, the UE reports the best SSBRI and corresponding RSRP to the BS. For example, if reportQuantity of the CSI-RS reportConfig IE is configured as “ssb-Index-RSRP”, the UE reports the best SSBRI and corresponding RSRP to the BS.

If a CSI-RS resource is configured in an OFDM symbol(s) identical with an SSB and “QCL-TypeD” is applicable, the UE may assume that the CSI-RS and the SSB have been quasi co-located (QCL) in the viewpoint of “QCL-TypeD.” In this case, QCL-TypeD may mean that antenna ports have been QCLed in the viewpoint of a spatial Rx parameter. The UE may apply the same reception beam when it receives the signals of a plurality of DL antenna ports having a QCL-TypeD relation.

Next, a DL BM process using a CSI-RS is described.

An Rx beam determination (or refinement) process of a UE and a Tx beam sweeping process of a BS using a CSI-RS are sequentially described. In the Rx beam determination process of the UE, a parameter is repeatedly set as “ON.” In the Tx beam sweeping process of the BS, a parameter is repeatedly set as “OFF.”

First, the Rx beam determination process of a UE is described.

The UE receives an NZP CSI-RS resource set IE, including an RRC parameter regarding “repetition”, from a BS through RRC signaling. In this case, the RRC parameter “repetition” has been set as “ON.”

The UE repeatedly receives signals on a resource(s) within a CSI-RS resource set in which the RRC parameter “repetition” has been set as “ON” in different OFDM symbols through the same Tx beam (or DL spatial domain transmission filter) of the BS.

The UE determines its own Rx beam.

The UE omits CSI reporting. That is, if the RRC parameter “repetition” has been set as “ON”, the UE may omit CSI reporting.

Next, the Tx beam determination process of a BS is described.

A UE receives an NZP CSI-RS resource set IE, including an RRC parameter regarding “repetition”, from the BS through RRC signaling. In this case, the RRC parameter “repetition” has been set as “OFF”, and is related to the Tx beam sweeping process of the BS.

The UE receives signals on resources within a CSI-RS resource set in which the RRC parameter “repetition” has been set as “OFF” through different Tx beams (DL spatial domain transmission filter) of the BS.

The UE selects (or determines) the best beam.

The UE reports, to the BS, the ID (e.g., CRI) of the selected beam and related quality information (e.g., RSRP). That is, the UE reports, to the BS, a CRI and corresponding RSRP, if a CSI-RS is transmitted for BM.

Next, an UL BM process using an SRS is described.

A UE receives, from a BS, RRC signaling (e.g., SRS-Config IE) including a use parameter configured (RRC parameter) as “beam management.” The SRS-Config IE is used for an SRS transmission configuration. The SRS-Config IE includes a list of SRS-Resources and a list of SRS-ResourceSets. Each SRS resource set means a set of SRS-resources.

The UE determines Tx beamforming for an SRS resource to be transmitted based on SRS-SpatialRelation Info included in the SRS-Config IE. In this case, SRS-SpatialRelation Info is configured for each SRS resource, and indicates whether to apply the same beamforming as beamforming used in an SSB, CSI-RS or SRS for each SRS resource.

If SRS-SpatialRelationInfo is configured in the SRS resource, the same beamforming as beamforming used in the SSB, CSI-RS or SRS is applied, and transmission is performed. However, if SRS-SpatialRelationInfo is not configured in the SRS resource, the UE randomly determines Tx beamforming and transmits an SRS through the determined Tx beamforming.

Next, a beam failure recovery (BFR) process is described.

In a beamformed system, a radio link failure (RLF) frequently occurs due to the rotation, movement or beamforming blockage of a UE. Accordingly, in order to prevent an RLF from occurring frequently, BFR is supported in NR. BFR is similar to a radio link failure recovery process, and may be supported when a UE is aware of a new candidate beam(s). For beam failure detection, a BS configures beam failure detection reference signals in a UE. If the number of beam failure indications from the physical layer of the UE reaches a threshold set by RRC signaling within a period configured by the RRC signaling of the BS, the UE declares a beam failure. After a beam failure is detected, the UE triggers beam failure recovery by initiating a random access process on a PCell, selects a suitable beam, and performs beam failure recovery (if the BS has provided dedicated random access resources for certain beams, they are prioritized by the UE). When the random access procedure is completed, the beam failure recovery is considered to be completed.

Ultra-Reliable and Low Latency Communication (URLLC)

URLLC transmission defined in NR may mean transmission for (1) a relatively low traffic size, (2) a relatively low arrival rate, (3) extremely low latency requirement (e.g., 0.5, 1 ms), (4) relatively short transmission duration (e.g., 2 OFDM symbols), and (5) an urgent service/message. In the case of the UL, in order to satisfy more stringent latency requirements, transmission for a specific type of traffic (e.g., URLLC) needs to be multiplexed with another transmission (e.g., eMBB) that has been previously scheduled. As one scheme related to this, information indicating that a specific resource will be preempted is provided to a previously scheduled UE, and the URLLC UE uses the corresponding resource for UL transmission.

In the case of NR, dynamic resource sharing between eMBB and URLLC is supported. EMBB and URLLC services may be scheduled on non-overlapping time/frequency resources. URLLC transmission may occur in resources scheduled for ongoing eMBB traffic. An eMBB UE may not be aware of whether the PDSCH transmission of a corresponding UE has been partially punctured. The UE may not decode the PDSCH due to corrupted coded bits. NR provides a preemption indication by taking this into consideration. The preemption indication may also be denoted as an interrupted transmission indication.

In relation to a preemption indication, a UE receives a DownlinkPreemption IE through RRC signaling from a BS. When the UE is provided with the DownlinkPreemption IE, the UE is configured with an INT-RNTI provided by a parameter int-RNTI within a DownlinkPreemption IE for the monitoring of a PDCCH that conveys DCI format 2_1. The UE is configured with a set of serving cells by INT-ConfigurationPerServing Cell, including a set of serving cell indices additionally provided by servingCellID, and a corresponding set of locations for fields within DCI format 2_1 by locationInDCI, configured with an information payload size for DCI format 2_1 by dci-PayloadSize, and configured with the indication granularity of time-frequency resources by timeFrequencySect.

The UE receives DCI format 2_1 from the BS based on the DownlinkPreemption IE.

When the UE detects DCI format 2_1 for a serving cell within a configured set of serving cells, the UE may assume that there is no transmission to the UE within PRBs and symbols indicated by the DCI format 2_1, among a set of the (last) monitoring period of a monitoring period and a set of symbols to which the DCI format 2_1 belongs. For example, the UE assumes that a signal within a time-frequency resource indicated by preemption is not DL transmission scheduled therefor, and decodes data based on signals reported in the remaining resource region.

Massive MTC (mMTC)

Massive machine type communication (mMTC) is one of 5G scenarios for supporting super connection service for simultaneous communication with many UEs. In this environment, a UE intermittently performs communication at a very low transmission speed and mobility. Accordingly, mMTC has a major object regarding how long will be a UE driven how low the cost is. In relation to the mMTC technology, in 3GPP, MTC and NarrowBand (NB)-IoT are handled.

The mMTC technology has characteristics, such as repetition transmission, frequency hopping, retuning, and a guard period for a PDCCH, a PUCCH, a physical downlink shared channel (PDSCH), and a PUSCH.

That is, a PUSCH (or PUCCH (in particular, long PUCCH) or PRACH) including specific information and a PDSCH (or PDCCH) including a response for specific information are repeatedly transmitted. The repetition transmission is performed through frequency hopping. For the repetition transmission, (RF) retuning is performed in a guard period from a first frequency resource to a second frequency resource. Specific information and a response for the specific information may be transmitted/received through a narrowband (e.g., 6 RB (resource block) or 1 RB).

Robot Basic Operation Using 5G Communication

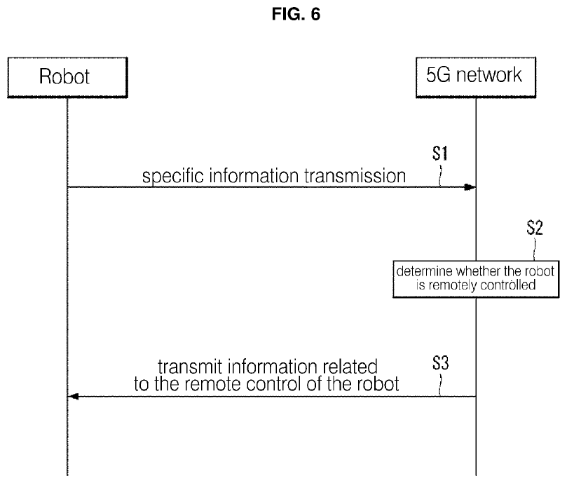

FIG. 6 shows an example of a basic operation of a robot and a 5G network in a 5G communication system.

A robot transmits specific information transmission to a 5G network (S1). Furthermore, the 5G network may determine whether the robot is remotely controlled (S2). In this case, the 5G network may include a server or module for performing robot-related remote control.

Furthermore, the 5G network may transmit, to the robot, information (or signal) related to the remote control of the robot (S3).

Application Operation Between Robot and 5G Network in 5G Communication System

Hereafter, a robot operation using 5G communication is described more specifically with reference to FIGS. 1 to 6 and the above-described wireless communication technology (BM procedure, URLLC, mMTC).

First, a basic procedure of a method to be proposed later in the present invention and an application operation to which the eMBB technology of 5G communication is applied is described.

As in steps S1 and S3 of FIG. 3, in order for a robot to transmit/receive a signal, information, etc. to/from a 5G network, the robot performs an initial access procedure and a random access procedure along with a 5G network prior to step S1 of FIG. 3.

More specifically, in order to obtain DL synchronization and system information, the robot performs an initial access procedure along with the 5G network based on an SSB. In the initial access procedure, a beam management (BM) process and a beam failure recovery process may be added. In a process for the robot to receive a signal from the 5G network, a quasi-co location (QCL) relation may be added.

Furthermore, the robot performs a random access procedure along with the 5G network for UL synchronization acquisition and/or UL transmission. Furthermore, the 5G network may transmit an UL grant for scheduling the transmission of specific information to the robot. Accordingly, the robot transmits specific information to the 5G network based on the UL grant. Furthermore, the 5G network transmits, to the robot, a DL grant for scheduling the transmission of a 5G processing result for the specific information. Accordingly, the 5G network may transmit, to the robot, information (or signal) related to remote control based on the DL grant.

A basic procedure of a method to be proposed later in the present invention and an application operation to which the URLLC technology of 5G communication is applied is described below.

As described above, after a robot performs an initial access procedure and/or a random access procedure along with a 5G network, the robot may receive a DownlinkPreemption IE from the 5G network. Furthermore, the robot receives, from the 5G network, DCI format 2_1 including pre-emption indication based on the DownlinkPreemption IE. Furthermore, the robot does not perform (or expect or assume) the reception of eMBB data in a resource (PRB and/or OFDM symbol) indicated by the pre-emption indication. Thereafter, if the robot needs to transmit specific information, it may receive an UL grant from the 5G network.

A basic procedure of a method to be proposed later in the present invention and an application operation to which the mMTC technology of 5G communication is applied is described below.

A portion made different due to the application of the mMTC technology among the steps of FIG. 6 is chiefly described.

In step S1 of FIG. 6, the robot receives an UL grant from the 5G network in order to transmit specific information to the 5G network. In this case, the UL grant includes information on the repetition number of transmission of the specific information. The specific information may be repeatedly transmitted based on the information on the repetition number. That is, the robot transmits specific information to the 5G network based on the UL grant. Furthermore, the repetition transmission of the specific information may be performed through frequency hopping. The transmission of first specific information may be performed in a first frequency resource, and the transmission of second specific information may be performed in a second frequency resource. The specific information may be transmitted through the narrowband of 6 resource blocks (RBs) or 1 RB.

Operation Between Robots Using 5G Communication

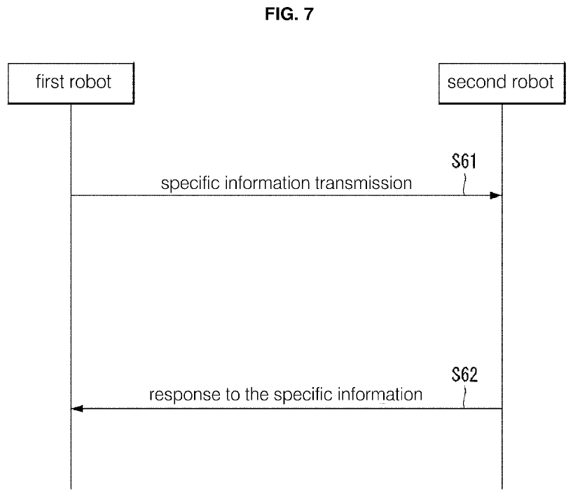

FIG. 7 illustrates an example of a basic operation between robots using 5G communication.

A first robot transmits specific information to a second robot (S61). The second robot transmits, to the first robot, a response to the specific information (S62).

Meanwhile, the configuration of an application operation between robots may be different depending on whether a 5G network is involved directly (sidelink communication transmission mode 3) or indirectly (sidelink communication transmission mode 4) in the specific information, the resource allocation of a response to the specific information.

An application operation between robots using 5G communication is described below.

First, a method for a 5G network to be directly involved in the resource allocation of signal transmission/reception between robots is described.

The 5G network may transmit a DCI format 5A to a first robot for the scheduling of mode 3 transmission (PSCCH and/or PSSCH transmission). In this case, the physical sidelink control channel (PSCCH) is a 5G physical channel for the scheduling of specific information transmission, and the physical sidelink shared channel (PSSCH) is a 5G physical channel for transmitting the specific information. Furthermore, the first robot transmits, to a second robot, an SCI format 1 for the scheduling of specific information transmission on a PSCCH. Furthermore, the first robot transmits specific information to the second robot on the PSSCH.

A method for a 5G network to be indirectly involved in the resource allocation of signal transmission/reception is described below.

A first robot senses a resource for mode 4 transmission in a first window. Furthermore, the first robot selects a resource for mode 4 transmission in a second window based on a result of the sensing. In this case, the first window means a sensing window, and the second window means a selection window. The first robot transmits, to the second robot, an SCI format 1 for the scheduling of specific information transmission on a PSCCH based on the selected resource. Furthermore, the first robot transmits specific information to the second robot on a PSSCH.

The above-described structural characteristic of the drone, the 5G communication technology, etc. may be combined with methods to be described, proposed in the present inventions, and may be applied or may be supplemented to materialize or clarify the technical characteristics of methods proposed in the present inventions.

Drone

Unmanned aerial system: a combination of a UAV and a UAV controller

Unmanned aerial vehicle: an aircraft that is remotely piloted without a human pilot, and it may be represented as an unmanned aerial robot, a drone, or simply a robot.

UAV controller: device used to control a UAV remotely

ATC: Air Traffic Control

NLOS: Non-line-of-sight

UAS: Unmanned Aerial System

UAV: Unmanned Aerial Vehicle

UCAS: Unmanned Aerial Vehicle Collision Avoidance System

UTM: Unmanned Aerial Vehicle Traffic Management

C2: Command and Control

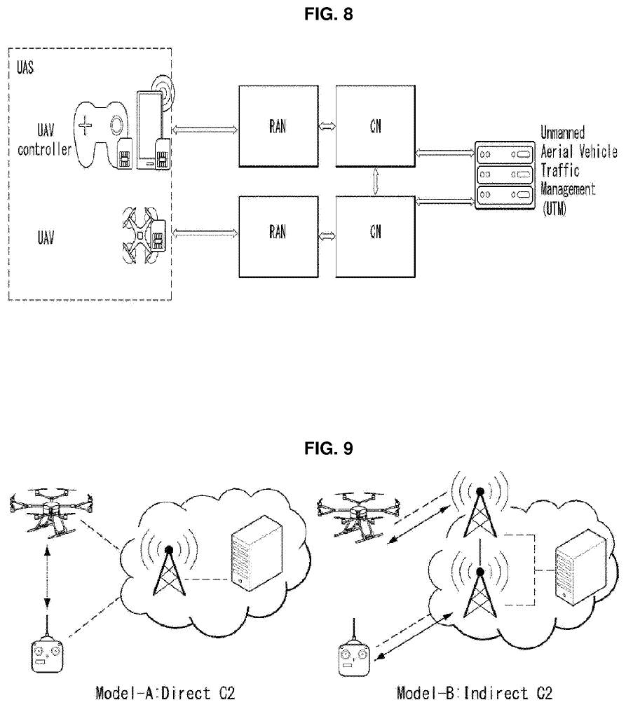

FIG. 8 is a diagram showing an example of the concept diagram of a 3GPP system including a UAS.

An unmanned aerial system (UAS) is a combination of an unmanned aerial vehicle (UAV), sometimes called a drone, and a UAV controller. The UAV is an aircraft not including a human pilot device. Instead, the UAV is controlled by a terrestrial operator through a UAV controller, and may have autonomous flight capabilities. A communication system between the UAV and the UAV controller is provided by the 3GPP system. In terms of the size and weight, the range of the UAV is various from a small and light aircraft that is frequently used for recreation purposes to a large and heavy aircraft that may be more suitable for commercial purposes. Regulation requirements are different depending on the range and are different depending on the area.

Communication requirements for a UAS include data uplink and downlink to/from a UAS component for both a serving 3GPP network and a network server, in addition to a command and control (C2) between a UAV and a UAV controller. Unmanned aerial system traffic management (UTM) is used to provide UAS identification, tracking, authorization, enhancement and the regulation of UAS operations and to store data necessary for a UAS for an operation. Furthermore, the UTM enables a certified user (e.g., air traffic control, public safety agency) to query an identity (ID), the meta data of a UAV, and the controller of the UAV.

The 3GPP system enables UTM to connect a UAV and a UAV controller so that the UAV and the UAV controller are identified as a UAS. The 3GPP system enables the UAS to transmit, to the UTM, UAV data that may include the following control information.

Control information: a unique identity (this may be a 3GPP identity), UE capability, manufacturer and model, serial number, take-off weight, location, owner identity, owner address, owner contact point detailed information, owner certification, take-off location, mission type, route data, an operating status of a UAV.

The 3GPP system enables a UAS to transmit UAV controller data to UTM. Furthermore, the UAV controller data may include a unique ID (this may be a 3GPP ID), the UE function, location, owner ID, owner address, owner contact point detailed information, owner certification, UAV operator identity confirmation, UAV operator license, UAV operator certification, UAV pilot identity, UAV pilot license, UAV pilot certification and flight plan of a UAV controller.

The functions of a 3GPP system related to a UAS may be summarized as follows.

A 3GPP system enables the UAS to transmit different UAS data to UTM based on different certification and an authority level applied to the UAS.

A 3GPP system supports a function of expanding UAS data transmitted to UTM along with future UTM and the evolution of a support application.

A 3GPP system enables the UAS to transmit an identifier, such as international mobile equipment identity (IMEI), a mobile station international subscriber directory number (MSISDN) or an international mobile subscriber identity (IMSI) or IP address, to UTM based on regulations and security protection.

A 3GPP system enables the UE of a UAS to transmit an identity, such as an IMEI, MSISDN or IMSI or IP address, to UTM.

A 3GPP system enables a mobile network operator (MNO) to supplement data transmitted to UTM, along with network-based location information of a UAV and a UAV controller.

A 3GPP system enables MNO to be notified of a result of permission so that UTM operates.

A 3GPP system enables MNO to permit a UAS certification request only when proper subscription information is present.

A 3GPP system provides the ID(s) of a UAS to UTM.

A 3GPP system enables a UAS to update UTM with live location information of a UAV and a UAV controller.

A 3GPP system provides UTM with supplement location information of a UAV and a UAV controller.

A 3GPP system supports UAVs, and corresponding UAV controllers are connected to other PLMNs at the same time.

A 3GPP system provides a function for enabling the corresponding system to obtain UAS information on the support of a 3GPP communication capability designed for a UAS operation.

A 3GPP system supports UAS identification and subscription data capable of distinguishing between a UAS having a UAS capable UE and a USA having a non-UAS capable UE.

A 3GPP system supports detection, identification, and the reporting of a problematic UAV(s) and UAV controller to UTM.

In the service requirement of Rel-16 ID_UAS, the UAS is driven by a human operator using a UAV controller in order to control paired UAVs. Both the UAVs and the UAV controller are connected using two individual connections over a 3GPP network for a command and control (C2) communication. The first contents to be taken into consideration with respect to a UAS operation include a mid-air collision danger with another UAV, a UAV control failure danger, an intended UAV misuse danger and various dangers of a user (e.g., business in which the air is shared, leisure activities). Accordingly, in order to avoid a danger in safety, if a 5G network is considered as a transmission network, it is important to provide a UAS service by QoS guarantee for C2 communication.

FIG. 9 shows examples of a C2 communication model for a UAV.

Model-A is direct C2. A UAV controller and a UAV directly configure a C2 link (or C2 communication) in order to communicate with each other, and are registered with a 5G network using a wireless resource that is provided, configured and scheduled by the 5G network, for direct C2 communication. Model-B is indirect C2. A UAV controller and a UAV establish and register respective unicast C2 communication links for a 5G network, and communicate with each other over the 5G network. Furthermore, the UAV controller and the UAV may be registered with the 5G network through different NG-RAN nodes. The 5G network supports a mechanism for processing the stable routing of C2 communication in any cases. A command and control use C2 communication for forwarding from the UAV controller/UTM to the UAV. C2 communication of this type (model-B) includes two different lower classes for incorporating a different distance between the UAV and the UAV controller/UTM, including a line of sight (VLOS) and a non-line of sight (non-VLOS). Latency of this VLOS traffic type needs to take into consideration a command delivery time, a human response time, and an assistant medium, for example, video streaming, the indication of a transmission waiting time. Accordingly, sustainable latency of the VLOS is shorter than that of the Non-VLOS. A 5G network configures each session for a UAV and a UAV controller. This session communicates with UTM, and may be used for default C2 communication with a UAS.

As part of a registration procedure or service request procedure, a UAV and a UAV controller request a UAS operation from UTM, and provide a pre-defined service class or requested UAS service (e.g., navigational assistance service, weather), identified by an application ID(s), to the UTM. The UTM permits the UAS operation for the UAV and the UAV controller, provides an assigned UAS service, and allocates a temporary UAS-ID to the UAS. The UTM provides a 5G network with information necessary for the C2 communication of the UAS. For example, the information may include a service class, the traffic type of UAS service, requested QoS of the permitted UAS service, and the subscription of the UAS service. When a request to establish C2 communication with the 5G network is made, the UAV and the UAV controller indicate a preferred C2 communication model (e.g., model-B) along with the UAS-ID allocated to the 5G network. If an additional C2 communication connection is to be generated or the configuration of the existing data connection for C2 needs to be changed, the 5G network modifies or allocates one or more QoS flows for C2 communication traffic based on requested QoS and priority in the approved UAS service information and C2 communication of the UAS.

UAV Traffic Management

(1) Centralized UAV Traffic Management

A 3GPP system provides a mechanism that enables UTM to provide a UAV with route data along with flight permission. The 3GPP system forwards, to a UAS, route modification information received from the UTM with latency of less than 500 ms. The 3GPP system needs to forward notification, received from the UTM, to a UAV controller having a waiting time of less than 500 ms.

(2) De-Centralized UAV Traffic Management

A 3GPP system broadcasts the following data (e.g., if it is requested based on another regulation requirement, UAV identities, UAV type, a current location and time, flight route information, current velocity, operation state) so that a UAV identifies a UAV(s) in a short-distance area for collision avoidance.

A 3GPP system supports a UAV in order to transmit a message through a network connection for identification between different UAVs. The UAV preserves owner's personal information of a UAV, UAV pilot and UAV operator in the broadcasting of identity information.

A 3GPP system enables a UAV to receive local broadcasting communication transmission service from another UAV in a short distance.

A UAV may use direct UAV versus UAV local broadcast communication transmission service in or out of coverage of a 3GPP network, and may use the direct UAV versus UAV local broadcast communication transmission service if transmission/reception UAVs are served by the same or different PLMNs.

A 3GPP system supports the direct UAV versus UAV local broadcast communication transmission service at a relative velocity of a maximum of 320 kmph. The 3GPP system supports the direct UAV versus UAV local broadcast communication transmission service having various types of message payload of 50-1500 bytes other than security-related message elements.

A 3GPP system supports the direct UAV versus UAV local broadcast communication transmission service capable of guaranteeing separation between UAVs. In this case, the UAVs may be considered to have been separated if they are in a horizontal distance of at least 50 m or a vertical distance of 30 m or both. The 3GPP system supports the direct UAV versus UAV local broadcast communication transmission service that supports the range of a maximum of 600 m.

A 3GPP system supports the direct UAV versus UAV local broadcast communication transmission service capable of transmitting a message with frequency of at least 10 message per second, and supports the direct UAV versus UAV local broadcast communication transmission service capable of transmitting a message whose inter-terminal waiting time is a maximum of 100 ms.

A UAV may broadcast its own identity locally at least once per second, and may locally broadcast its own identity up to a 500 m range.

Security

A 3GPP system protects data transmission between a UAS and UTM. The 3GPP system provides protection against the spoofing attack of a UAS ID. The 3GPP system permits the non-repudiation of data, transmitted between the UAS and the UTM, in the application layer. The 3GPP system supports the integrity of a different level and the capability capable of providing a personal information protection function with respect to a different connection between the UAS and the UTM, in addition to data transmitted through a UAS and UTM connection. The 3GPP system supports the classified protection of an identity and personal identification information related to the UAS. The 3GPP system supports regulation requirements (e.g., lawful intercept) for UAS traffic.

When a UAS requests the authority capable of accessing UAS data service from an MNO, the MNO performs secondary check (after initial mutual certification or simultaneously with it) in order to establish UAS qualification verification to operate. The MNO is responsible for transmitting and potentially adding additional data to the request so that the UAS operates as unmanned aerial system traffic management (UTM). In this case, the UTM is a 3GPP entity. The UTM is responsible for the approval of the UAS that operates and identifies the qualification verification of the UAS and the UAV operator. One option is that the UTM is managed by an aerial traffic control center. The aerial traffic control center stores all data related to the UAV, the UAV controller, and live location. When the UAS fails in any part of the check, the MNO may reject service for the UAS and thus may reject operation permission.

3GPP Support for Aerial UE (or Drone) Communication

An E-UTRAN-based mechanism that provides an LTE connection to a UE capable of aerial communication is supported through the following functions.

Subscription-based aerial UE identification and authorization defined in Section TS 23.401, 4.3.31.

Height reporting based on an event in which the altitude of a UE exceeds a reference altitude threshold configured with a network.

Interference detection based on measurement reporting triggered when the number of configured cells (i.e., greater than 1) satisfies a triggering criterion at the same time.

Signaling of flight route information from a UE to an E-UTRAN.

Location information reporting including the horizontal and vertical velocity of a UE.

(1) Subscription-Based Identification of Aerial UE Function

The support of the aerial UE function is stored in user subscription information of an HSS. The HSS transmits the information to an MME in an Attach, Service Request and Tracking Area Update process. The subscription information may be provided from the MME to a base station through an S1 AP initial context setup request during the Attach, tracking area update and service request procedure. Furthermore, in the case of X2-based handover, a source base station (BS) may include subscription information in an X2-AP Handover Request message toward a target BS. More detailed contents are described later. With respect to intra and inter MME S1-based handover, the MME provides subscription information to the target BS after the handover procedure.

(2) Height-Based Reporting for Aerial UE Communication

An aerial UE may be configured with event-based height reporting. The aerial UE transmits height reporting when the altitude of the UE is higher or lower than a set threshold. The reporting includes height and a location.

(3) Interference Detection and Mitigation for Aerial UE Communication

For interference detection, when each (per cell) RSRP value for the number of configured cells satisfies a configured event, an aerial UE may be configured with an RRM event A3, A4 or A5 that triggers measurement reporting. The reporting includes an RRM result and location. For interference mitigation, the aerial UE may be configured with a dedicated UE-specific alpha parameter for PUSCH power control.

(4) Flight Route Information Reporting

An E-UTRAN may request a UE to report flight route information configured with a plurality of middle points defined as 3D locations, as defined in TS 36.355. If the flight route information is available for the UE, the UE reports a waypoint for a configured number. The reporting may also include a time stamp per waypoint if it is configured in the request and available for the UE.

(5) Location Reporting for Aerial UE Communication

Location information for aerial UE communication may include a horizontal and vertical velocity if they have been configured. The location information may be included in the RRM reporting and the height reporting.

Hereafter, (1) to (5) of 3GPP support for aerial UE communication is described more specifically.

DL/UL Interference Detection

For DL interference detection, measurements reported by a UE may be useful. UL interference detection may be performed based on measurement in a base station or may be estimated based on measurements reported by a UE. Interference detection can be performed more effectively by improving the existing measurement reporting mechanism. Furthermore, for example, other UE-based information, such as mobility history reporting, speed estimation, a timing advance adjustment value, and location information, may be used by a network in order to help interference detection. More detailed contents of measurement execution are described later.

DL Interference Mitigation

In order to mitigate DL interference in an aerial UE, LTE Release-13 FD-MIMO may be used. Although the density of aerial UEs is high, Rel-13 FD-MIMO may be advantageous in restricting an influence on the DL terrestrial UE throughput, while providing a DL aerial UE throughput that satisfies DL aerial UE throughput requirements. In order to mitigate DL interference in an aerial UE, a directional antenna may be used in the aerial UE. In the case of a high-density aerial UE, a directional antenna in the aerial UE may be advantageous in restricting an influence on a DL terrestrial UE throughput. The DL aerial UE throughput has been improved compared to a case where a non-directional antenna is used in the aerial UE. That is, the directional antenna is used to mitigate interference in the downlink for aerial UEs by reducing interference power from wide angles. In the viewpoint that a LOS direction between an aerial UE and a serving cell is tracked, the following types of capability are taken into consideration:

1) Direction of Travel (DoT): an aerial UE does not recognize the direction of a serving cell LOS, and the antenna direction of the aerial UE is aligned with the DoT.

2) Ideal LOS: an aerial UE perfectly tracks the direction of a serving cell LOS and pilots the line of sight of an antenna toward a serving cell.

3) Non-ideal LOS: an aerial UE tracks the direction of a serving cell LOS, but has an error due to actual restriction.

In order to mitigate DL interference with aerial UEs, beamforming in aerial UEs may be used. Although the density of aerial UEs is high, beamforming in the aerial UEs may be advantageous in restricting an influence on a DL terrestrial UE throughput and improving a DL aerial UE throughput. In order to mitigate DL interference in an aerial UE, intra-site coherent JT CoMP may be used. Although the density of aerial UEs is high, the intra-site coherent JT can improve the throughput of all UEs. An LTE Release-13 coverage extension technology for non-bandwidth restriction devices may also be used. In order to mitigate DL interference in an aerial UE, a coordinated data and control transmission method may be used. An advantage of the coordinated data and control transmission method is to increase an aerial UE throughput, while restricting an influence on a terrestrial UE throughput. It may include signaling for indicating a dedicated DL resource, an option for cell muting/ABS, a procedure update for cell (re)selection, acquisition for being applied to a coordinated cell, and the cell ID of a coordinated cell.

UL Interference Mitigation

In order to mitigate UL interference caused by aerial UEs, an enhanced power control mechanisms may be used. Although the density of aerial UEs is high, the enhanced power control mechanism may be advantageous in restricting an influence on a UL terrestrial UE throughput.

The above power control-based mechanism influences the following contents.

UE-specific partial pathloss compensation factor

UE-specific Po parameter

Neighbor cell interference control parameter

Closed-loop power control

The power control-based mechanism for UL interference mitigation is described more specifically.

1) UE-Specific Partial Pathloss Compensation Factor

The enhancement of the existing open-loop power control mechanism is taken into consideration in the place where a UE-specific partial pathloss compensation factor αUE is introduced. Due to the introduction of the UE-specific partial pathloss compensation factor αUE, different αUE may be configured by comparing an aerial UE with a partial pathloss compensation factor configured in a terrestrial UE.

2) UE-Specific PO Parameter

Aerial UEs are configured with different Po compared with Po configured for terrestrial UEs. The enhance of the existing power control mechanism is not necessary because the UE-specific Po is already supported in the existing open-loop power control mechanism.

Furthermore, the UE-specific partial pathloss compensation factor αUE and the UE-specific Po may be used in common for uplink interference mitigation. Accordingly, the UE-specific partial pathloss compensation factor αUE and the UE-specific Po can improve the uplink throughput of a terrestrial UE, while scarifying the reduced uplink throughput of an aerial UE.

3) Closed-Loop Power Control

Target reception power for an aerial UE is coordinated by taking into consideration serving and neighbor cell measurement reporting. Closed-loop power control for aerial UEs needs to handle a potential high-speed signal change in the sky because aerial UEs may be supported by the sidelobes of base station antennas.

In order to mitigate UL interference attributable to an aerial UE, LTE Release-13 FD-MIMO may be used. In order to mitigate UL interference caused by an aerial UE, a UE-directional antenna may be used. In the case of a high-density aerial UE, a UE-directional antenna may be advantageous in restricting an influence on an UL terrestrial UE throughput. That is, the directional UE antenna is used to reduce uplink interference generated by an aerial UE by reducing a wide angle range of uplink signal power from the aerial UE. The following type of capability is taken into consideration in the viewpoint in which an LOS direction between an aerial UE and a serving cell is tracked:

1) Direction of Travel (DoT): an aerial UE does not recognize the direction of a serving cell LOS, and the antenna direction of the aerial UE is aligned with the DoT.

2) Ideal LOS: an aerial UE perfectly tracks the direction of a serving cell LOS and pilots the line of sight of the antenna toward a serving cell.

3) Non-ideal LOS: an aerial UE tracks the direction of a serving cell LOS, but has an error due to actual restriction.

A UE may align an antenna direction with an LOS direction and amplify power of a useful signal depending on the capability of tracking the direction of an LOS between the aerial UE and a serving cell. Furthermore, UL transmission beamforming may also be used to mitigate UL interference.

Mobility

Mobility performance (e.g., a handover failure, a radio link failure (RLF), handover stop, a time in Qout) of an aerial UE is weakened compared to a terrestrial UE. It is expected that the above-described DL and UL interference mitigation technologies may improve mobility performance for an aerial UE. Better mobility performance in a rural area network than in an urban area network is monitored. Furthermore, the existing handover procedure may be improved to improve mobility performance.

Improvement of a handover procedure for an aerial UE and/or mobility of a handover-related parameter based on location information and information, such as the aerial state of a UE and a flight route plan

A measurement reporting mechanism may be improved in such a way as to define a new event, enhance a trigger condition, and control the quantity of measurement reporting.

The existing mobility enhancement mechanism (e.g., mobility history reporting, mobility state estimation, UE support information) operates for an aerial UE and may be first evaluated if additional improvement is necessary. A parameter related to a handover procedure for an aerial UE may be improved based on aerial state and location information of the UE. The existing measurement reporting mechanism may be improved by defining a new event, enhancing a triggering condition, and controlling the quantity of measurement reporting. Flight route plan information may be used for mobility enhancement.

A measurement execution method which may be applied to an aerial UE is described more specifically.

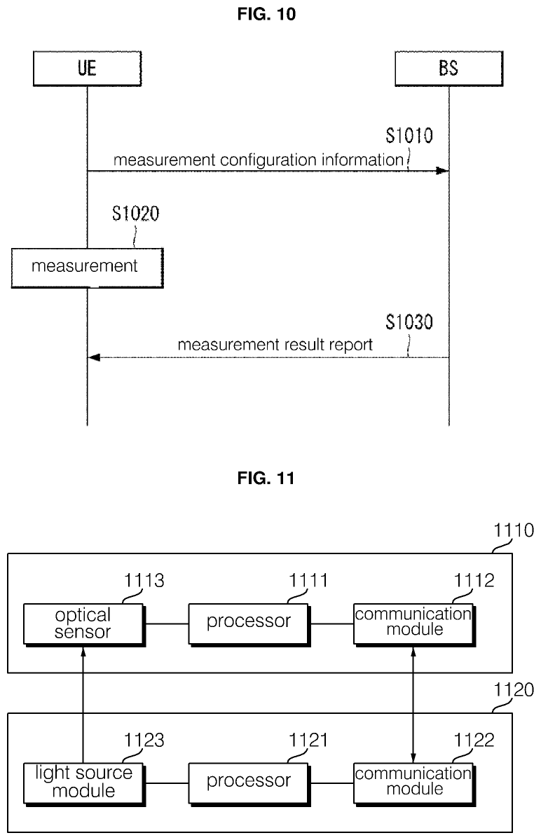

FIG. 10 is a flowchart showing an example of a measurement execution method to which the present invention is applicable.

An aerial UE receives measurement configuration information from a base station (S1010). In this case, a message including the measurement configuration information is called a measurement configuration message. The aerial UE performs measurement based on the measurement configuration information (S1020). If a measurement result satisfies a reporting condition within the measurement configuration information, the aerial UE reports the measurement result to the base station (S1030). A message including the measurement result is called a measurement report message. The measurement configuration information may include the following information.

(1) Measurement object information: this is information on an object on which an aerial UE will perform measurement. The measurement object includes at least one of an intra-frequency measurement object that is an object of measurement within a cell, an inter-frequency measurement object that is an object of inter-cell measurement, or an inter-RAT measurement object that is an object of inter-RAT measurement. For example, the intra-frequency measurement object may indicate a neighbor cell having the same frequency band as a serving cell. The inter-frequency measurement object may indicate a neighbor cell having a frequency band different from that of a serving cell. The inter-RAT measurement object may indicate a neighbor cell of an RAT different from the RAT of a serving cell.

(2) Reporting configuration information: this is information on a reporting condition and reporting type regarding when an aerial UE reports the transmission of a measurement result. The reporting configuration information may be configured with a list of reporting configurations. Each reporting configuration may include a reporting criterion and a reporting format. The reporting criterion is a level in which the transmission of a measurement result by a UE is triggered. The reporting criterion may be the periodicity of measurement reporting or a single event for measurement reporting. The reporting format is information regarding that an aerial UE will configure a measurement result in which type.

An event related to an aerial UE includes (i) an event H1 and (ii) an event H2.

Event H1 (Aerial UE Height Exceeding a Threshold)

A UE considers that an entering condition for the event is satisfied when 1) the following defined condition H1-1 is satisfied, and considers that a leaving condition for the event is satisfied when 2) the following defined condition H1-2 is satisfied.

Inequality H1-1 (entering condition):

Ms-Hys>Thresh+Offset

Inequality H1-2 (leaving condition):

Ms+Hys<Thresh+Offset

In the above equation, the variables are defined as follows.

Ms is an aerial UE height and does not take any offset into consideration. Hys is a hysteresis parameter (i.e., h1-hysteresis as defined in ReportConfigEUTRA) for an event. Thresh is a reference threshold parameter variable for the event designated in MeasConfig (i.e., heightThresh Ref defined within MeasConfig). Offset is an offset value for heightThreshRef for obtaining an absolute threshold for the event (i.e., h1-ThresholdOffset defined in ReportConfigEUTRA). Ms is indicated in meters. Thresh is represented in the same unit as Ms.

Event H2 (Aerial UE Height of Less than Threshold)

A UE considers that an entering condition for an event is satisfied 1) the following defined condition H2-1 is satisfied, and considers that a leaving condition for the event is satisfied 2) when the following defined condition H2-2 is satisfied.

Inequality H2-1 (Entering Condition):

Ms+Hys<Thresh+Offset

Inequality H2-2 (leaving condition):

Ms-Hys>Thresh+Offset

In the above equation, the variables are defined as follows.

Ms is an aerial UE height and does not take any offset into consideration. Hys is a hysteresis parameter (i.e., h1-hysteresis as defined in ReportConfigEUTRA) for an event. Thresh is a reference threshold parameter variable for the event designated in MeasConfig (i.e., heightThresh Ref defined within MeasConfig). Offset is an offset value for heightThreshRef for obtaining an absolute threshold for the event (i.e., h2-ThresholdOffset defined in ReportConfigEUTRA). Ms is indicated in meters. Thresh is represented in the same unit as Ms.

(3) Measurement identity information: this is information on a measurement identity by which an aerial UE determines to report which measurement object using which type by associating the measurement object and a reporting configuration. The measurement identity information is included in a measurement report message, and may indicate that a measurement result is related to which measurement object and that measurement reporting has occurred according to which reporting condition.

(4) Quantity configuration information: this is information on a parameter for configuring filtering of a measurement unit, a reporting unit and/or a measurement result value.

(5) Measurement gap information: this is information on a measurement gap, that is, an interval which may be used by an aerial UE in order to perform only measurement without taking into consideration data transmission with a serving cell because downlink transmission or uplink transmission has not been scheduled in the aerial UE.

In order to perform a measurement procedure, an aerial UE has a measurement object list, a measurement reporting configuration list, and a measurement identity list. If a measurement result of the aerial UE satisfies a configured event, the UE transmits a measurement report message to a base station.

In this case, the following parameters may be included in a UE-EUTRA-Capability Information Element in relation to the measurement reporting of the aerial UE. IE UE-EUTRA-Capability is used to forward, to a network, an E-RA UE Radio Access Capability parameter and a function group indicator for an essential function. IE UE-EUTRA-Capability is transmitted in an E-UTRA or another RAT. Table 1 is a table showing an example of the UE-EUTRA-Capability IE.

TABLE 1

| | |
|---|---|
| --ASN1START..... MeasParameters-v1530 ::= | SEQUENCE {qoe-MeasReport- |

r15
ENUMERATED {supported} OPTIONAL, qoe-MTSI-MeasReport-r15
ENUMERATED {supported} OPTIONAL, ca-IdleModeMeasurements-r15
ENUMERATED {supported} OPTIONAL, ca-IdleModeValidityArea-r15

| | |
|---|---|
| ENUMERATED {supported} OPTIONAL, heightMeas-r15 | ENUMERATED |

{supported} OPTIONAL, multipleCellsMeasExtension-r15
ENUMERATED {supported} OPTIONAL}.....

The heightMeas-r15 field defines whether a UE supports height-based measurement reporting defined in TS 36.331. As defined in TS 23.401, to support this function with respect to a UE having aerial UE subscription is essential. The multipleCellsMeasExtension-r15 field defines whether a UE supports measurement reporting triggered based on a plurality of cells. As defined in TS 23.401, to support this function with respect to a UE having aerial UE subscription is essential.

UAV UE Identification

A UE may indicate a radio capability in a network which may be used to identify a UE having a related function for supporting a UAV-related function in an LTE network. A permission that enables a UE to function as an aerial UE in the 3GPP network may be aware based on subscription information transmitted from the MME to the RAN through S1 signaling. Actual “aerial use” certification/license/restriction of a UE and a method of incorporating it into subscription information may be provided from a Non-3GPP node to a 3GPP node. A UE in flight may be identified using UE-based reporting (e.g., mode indication, altitude or location information during flight, an enhanced measurement reporting mechanism (e.g., the introduction of a new event) or based on mobility history information available in a network.

Subscription Handling for Aerial UE

The following description relates to subscription information processing for supporting an aerial UE function through the E-UTRAN defined in TS 36.300 and TS 36.331. An eNB supporting aerial UE function handling uses information for each user, provided by the MME, in order to determine whether the UE can use the aerial UE function. The support of the aerial UE function is stored in subscription information of a user in the HSS. The HSS transmits the information to the MME through a location update message during an attach and tracking area update procedure. A home operator may cancel the subscription approval of the user for operating the aerial UE at any time. The MME supporting the aerial UE function provides the eNB with subscription information of the user for aerial UE approval through an S1 AP initial context setup request during the attach, tracking area update and service request procedure.

An object of an initial context configuration procedure is to establish all required initial UE context, including E-RAB context, a security key, a handover restriction list, a UE radio function, and a UE security function. The procedure uses UE-related signaling.

In the case of Inter-RAT handover to intra- and inter-MME S1 handover (intra RAT) or E-UTRAN, aerial UE subscription information of a user includes an S1-AP UE context modification request message transmitted to a target BS after a handover procedure.

An object of a UE context change procedure is to partially change UE context configured as a security key or a subscriber profile ID for RAT/frequency priority, for example. The procedure uses UE-related signaling.

In the case of X2-based handover, aerial UE subscription information of a user is transmitted to a target BS as follows:

If a source BS supports the aerial UE function and aerial UE subscription information of a user is included in UE context, the source BS includes corresponding information in the X2-AP handover request message of a target BS.

An MME transmits, to the target BS, the aerial UE subscription information in a Path Switch Request Acknowledge message.

An object of a handover resource allocation procedure is to secure, by a target BS, a resource for the handover of a UE.

If aerial UE subscription information is changed, updated aerial UE subscription information is included in an S1-AP UE context modification request message transmitted to a BS.

Table 2 is a table showing an example of the aerial UE subscription information.

TABLE 2

| | | | |
|---|---|---|---|
| IE/Group Name | Presence | Range | IE type and reference |

| | | |
|---|---|---|
| Aerial UE | M | ENUMERATED |
| subscription | | (allowed, not allowed . . .) |
| information | | |

Aerial UE subscription information is used by a BS in order to know whether a UE can use the aerial UE function.

Combination of Drone and eMBB

A 3GPP system can support data transmission for a UAV (aerial UE or drone) and for an eMBB user at the same time.

A base station may need to support data transmission for an aerial UAV and a terrestrial eMBB user at the same time under a restricted bandwidth resource. For example, in a live broadcasting scenario, a UAV of 100 meters or more requires a high transmission speed and a wide bandwidth because it has to transmit, to a base station, a captured figure or video in real time. At the same time, the base station needs to provide a requested data rate to terrestrial users (e.g., eMBB users). Furthermore, interference between the two types of communications needs to be minimized.

FIG. 11 is a block diagram showing a control relationship between main components of an aerial control system according to the embodiment of the present invention.

Referring to FIG. 11, the aerial control system according to an embodiment of the present invention may include an unmanned aerial vehicle (it may be replaced with a drone or an unmanned flying robot in the specification) 1110 and a station 1120.

The unmanned aerial vehicle 1110 may include a communication module 1112 capable of wireless communication with a server 200, a terminal 300, a station 1120, other drones, robots, and the like, and a processor 1111 that controls the overall operation.

The processor 1111 may control overall operation of the unmanned aerial vehicle 100 through control of various components constituting the unmanned aerial vehicle 100.

According to an embodiment of the present invention, the processor 1111 may correspond to the controller 140 of FIG. 1, and the communication module 1112 may correspond to the drone communication module 175.

The unmanned aerial vehicle 1110 according to an embodiment of the present invention may include a main body 20 in FIG. 1, at least one motor 12 in FIG. 1 provided in the main body 20, and at least one propeller 11 in FIG. 1 connected to each at least one motor 12, a sensing module having various sensors 130 in FIG. 2, and, a processor 1111 that controls the operation of various components(the communication module 1112, the motor 12, the sensing module 130, and the communication module 1112).

The sensing module 130 may include an optical sensor 1113 provided on the main body 20 and recognizing at least some of the lights output from light sources of the station 1120. According to an embodiment, the optical sensor 1113 may include a plurality of light reception modules, and each light reception module may detect one or more light.

The processor 1111 may receive and process recognition information from the optical sensor 1113. In particular, the processor 1111 may determine the current location of the unmanned aerial vehicle 100 based on the light recognized by the optical sensor 1113.

Station 1120 according to an embodiment of the present invention, a communication module 1122 capable of wireless communication with the server 200, the terminal 300, the drone 1110, other stations, robots, etc., and a processor 1121 that controls the overall operation.

The communication modules 1112 and 1122 may include a receiver and a transmitter to receive and transmit wireless signals.

The aerial control system according to an embodiment of the present invention may determine the location and/or altitude of the drone 1110 using light. In addition, it is possible to perform posture control and landing control of the drone 1110 using light.

To this end, the station 1120 may include a light source module 1123 including light sources. In addition, the unmanned aerial vehicle 1110 may include one or more optical sensors 1113 and recognize light output from at least one of the light sources of the light source module 1123.

The unmanned aerial vehicle 1110 according to an embodiment of the present invention includes a communication module 1122, a light source module 1123 including a plurality of light sources in which at least one of the frequency, size, and length of the output light is set differently, and a processor 1121 for controlling blinking of a plurality of light sources included in the light source module 1123.

In the present specification, modulation may mean changing an optical signal output from a light source. For example, modulation may mean changing at least one of a (blinking) frequency, a size (amount of light), and a length of a section in which the light source is turned on. In this case, the modulation information may mean information about the frequency, size, and length of light output from the light source.

Meanwhile, according to an embodiment of the present invention, predetermined information may be transmitted by indicating a data value of I/O in an on/off period of an optical signal output from a light source. In addition, according to an embodiment of the present invention, predetermined information such as a control signal may be transmitted to an optical signal output from a light source. In this case, the basic optical signal output from each light source may function as a carrier wave. Accordingly, modulation may mean changing an optical signal for transmission of predetermined information.

The unmanned aerial vehicle 1110 may acquire information necessary for location recognition, altitude recognition, and posture recognition based on an optical signal recognized by the optical sensor 1113. In particular, light output from the light source module 1123 may be used for precise landing control, and the unmanned aerial vehicle 1110 may acquire information for landing control based on an optical signal recognized by the optical sensor 1113.

According to an embodiment of the present invention, the processor 1111 may determine at least one of the current location, posture, and altitude of the unmanned aerial vehicle 100 based on an optical signal recognized by the optical sensor 1113.

The light sources of the station 1120 have different modulation information of at least one of the frequencies, sizes, and lengths of the output lights. Hence the processor 1111 may identify the light source that outputs the light recognized in the optical sensor 1113 using the differently set modulation information to the optical sensor 1113. Since the light and the light source that outputs the light can be distinguished from other light/light sources, location information of the corresponding light source can also be used. Accordingly, the processor 1111 may more accurately determine the current location of the unmanned aerial vehicle 1110 based on the location information of the identified light source.

Here, the location information of the corresponding light source may be previously stored in the storage 150 or may be received through the communication module 1112. Depending on an embodiment, the location information of the corresponding light source may be included in the optical signal output from the light source module 1123.

The light sources of the light source module 1123 may be located at an appropriate landing point according to the design of the station 1120 and/or the operation method of the unmanned aerial vehicle control system. For example, the light sources of the light source module 1123 may be locationed on the upper landing surface of the station 1120 to output light upward. Alternatively, when the station 1120 includes a cover, the light sources of the light source module 1123 may be locationed inside the station 1120 and output light upward from the landing surface when the cover is opened. Alternatively, the light sources of the light source module 1123 may be located on the ground or other structures separately from the station 1120 to output light upward.

According to an embodiment of the present invention, the station 1120 may include a plurality of light emitting pads, and each of the plurality of light emitting pads may include one or more light sources. Here, each light source may differently set at least one of modulation information such as a frequency, a size, and a length of output light from different light sources.

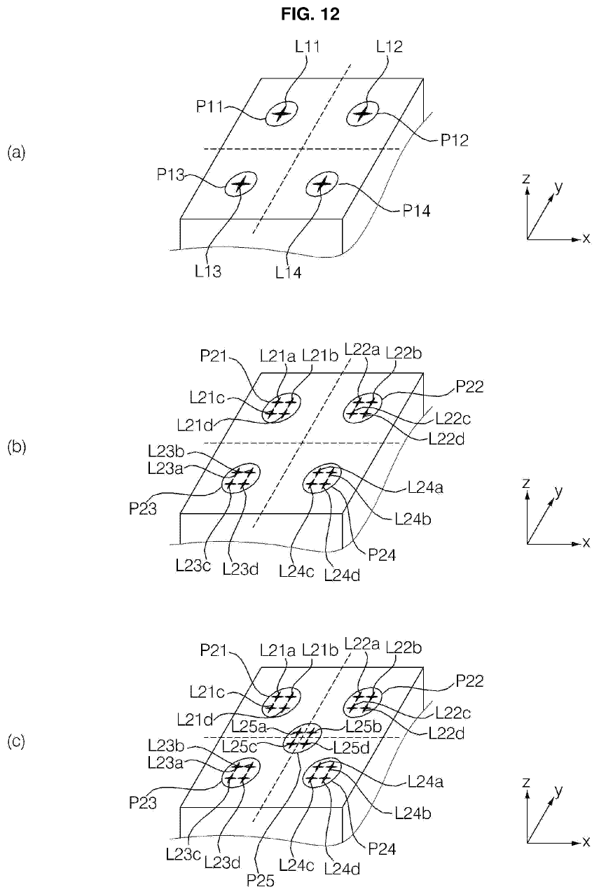

FIG. 12 shows examples of an arrangement of a light source according to embodiments of the present invention.

In the specification, the horizontal plane refers to an xy plane parallel to the landing surface provided in the station 1120 for landing of the unmanned aerial vehicle 1110, and the vertical direction refers to a z-axis direction perpendicular to the horizontal plane. Depending on the arrangement of the station 1120 and the light source, the horizontal plane may be replaced with the ground, and the vertical direction may be a z-axis direction perpendicular to the ground.

Referring to FIG. 12(a), four light emitting pads P11, P12, P13, and P14 may be disposed on the landing surface of the station 1120. Each of the light emitting pads P11, P12, P13, and P14 may include one light source L11, L12, L13, and L14.

The light sources L11, L12, L13, and L14 may output light in the upward direction in which the unmanned aerial vehicle 1110 is in flight. For example, the light sources L11, L12, L13, and L14 may output light in a vertical direction. According to an embodiment, at least some of the light sources L11, L12, L13, and L14 may output light inclined at a predetermined angle in a vertical direction.

For the light sources L11, L12, L13, and L14, at least one of modulation information such as a frequency, a size, and a length of light output from other light sources may be set differently.

For example, the light sources L11, L12, L13, and L14 may flicker at different frequencies. For example, the first light source L11 may blink according to a frequency of 10 Hz, the second light source L12 is 20 Hz, the third light source L3 is 30 Hz, and the fourth light source L4 is 40 Hz. In this case, the processor 1111 of the unmanned aerial vehicle 1110 may identify a light source that outputs the corresponding light among the light sources L11, L12, L13, and L14 at the frequency of light recognized by the optical sensor 1113. In addition, the processor 1111 may more accurately determine the location information of the unmanned aerial vehicle 1110 by using location information such as x and y coordinates of the identified light source.

In addition, during the landing operation, the processor 1111 may perform landing control using any one of the four light emitting pads P11, P12, P13, and P14 as a landing point according to a setting or control command. Alternatively, landing control may be performed to the identified landing point by determining a location corresponding to the landing point coordinate based on any one of the four light emitting pads P11, P12, P13, and P14.

The unmanned aerial vehicle 1110 may determine its own location according to the recognized light source, and it enables precise control to a target landing point based on this.

The processor 1111 may control the motor 12 to move the unmanned aerial vehicle 1110 to the landing point of the station 1120 based on the determined current location.

Meanwhile, the light sources L11, L12, L13, and L14 are preferably laser light sources in order to utilize the unmanned aerial vehicle 1110 for precise control. In particular, it is more preferable to use a laser light source because it is very important to ensure the straightness of the light in the case of altitude calculation.

Referring to FIG. 12(b), four light emitting pads P21, P22, P23, and P24 may be disposed on the landing surface of the station 1120. Each of the light emitting pads P21, P22, P23, and P24 may include a plurality of light sources. For example, the light emitting pads P21, P22, P23, and P24 may each include four light sources. Referring to (b) of FIG. 12, the P21 light emitting pad includes four light sources 21a, 21b, 21c, and 21d, and the P22 light emitting pad includes four light sources 22a, 22b, 22c, and 22d, The P23 light emitting pad may include four light sources 23a, 23b, 23c, and 23d, and the P24 light emitting pad may include four light sources 24a, 24b, 24c, and 24d.

Meanwhile, it is preferable to set the modulation information of all the light sources 21a-21d, 22a-22d, 23a-23d, and 24a-24d differently. For example, frequencies of all the light sources 21a-21d, 22a-22d, 23a-23d, and 24a-24d may be set differently. Accordingly, the processor 1111 may identify all light sources that output light received by the optical sensor 1113.

In some cases, only one of the light sources 21a-21d, 22a-22d, 23a-23d, 24a-24d for each light-emitting pad P21, P22, P23, P24 is set differently to distinguish the light-emitting pad. It can also be used for purposes.

Referring to FIG. 12(c), five light emitting pads P21, P22, P23, P24, and P25 may be disposed on the landing surface of the station 1120. FIG. 12(c) shows the addition of a P25 light emitting pad in the example of FIG. 12(b). The P25 light emitting pad may also include a plurality of light sources 25a, 25b, 25c, and 25d.

In the examples of (b) and (c) of FIG. 12, the light sources 21a-21d, 22a-22d, 23a-23d, 24a-24d, and 25a-25d light up the unmanned aerial vehicle 1110 in flight. For example, the light sources 21a-21d, 22a-22d, 23a-23d, 24a-24d, and 25a-25d may output light in a vertical direction. According to an embodiment, at least some of the light sources 21a-21d, 22a-22d, 23a-23d, 24a-24d, and 25a-25d may output light inclined at a predetermined angle in the vertical direction.

Meanwhile, in order to utilize the unmanned aerial vehicle 1110 for precise control, the light sources 21a-21d, 22a-22d, 23a-23d, 24a-24d, and 25a-25d are preferably laser light sources. In particular, it is more preferable to use a laser light source because it is very important to ensure the straightness of the light in the case of altitude calculation.

In case of the light emitting pads P21, P22, P23, P24, and P25 each include a plurality of light sources, the number of light sources and arrangement form of the included light emitting pads P21, P22, P23, P24, and P25 may vary. For example, the light emitting pads P21, P22, P23, P24, and P25 may each include three light sources, and may be asymmetrically disposed within the landing surface. According to embodiments of the present invention, since a light source can be identified by a difference in modulation information such as a frequency, a size, and a length of the lights, the symmetry of the light source arrangement or a specific geometric arrangement form is not necessarily required. Accordingly, according to embodiments of the present invention, there is an advantage in that the number and arrangement form of light sources can be more freely designed.

The number of stations 1120 may be plural, and each of the stations 1120 may be distinguished by a unique ID (ID). The station ID is assigned to the unmanned aerial vehicle 1110, so that a station 1120 for the purpose of operations such as landing, take-off, charging, and/or storage may be assigned.

The unmanned aerial vehicle 1110 may be plural, and each of the unmanned aerial vehicle 1110 can be distinguished by a unique ID (Identifier). The station 1120 may also be assigned a drone 1110 for the purpose of operation of the station 1120 through a drone ID.

The unmanned aerial vehicle control system may provide the drone 1110 with location information of light sources previously input and managed, so that the unmanned aerial vehicle 1110 can determine its own location.

Light sources installed and operated in relation to the station 1120 may provide information on the station 1120 to the unmanned aerial vehicle 1110. Such station 1120 information includes station ID, station direction, location (e.g. latitude, longitude), function (e.g., charging, storage), number of unmanned aerial vehicles 1110 that can be loaded, number of unmanned aerial vehicles 1110 that can land. And the like.

According to an embodiment of the present invention, the processor 1111 may perform a posture control of the unmanned aerial vehicle 1110 based on location information of the identified light source.

According to an embodiment of the present invention, the processor 1111 may control a heading angle of the unmanned aerial vehicle 1110 based on location information of the identified light source. For example, the processor 1111 may control the direction angle by rotating the unmanned aerial vehicle 1110 so that the light-receiving location of the optical sensor 1113 coincides with a reference location set to correspond to the arrangement location of the light sources.

In addition, the processor 1111 may determine the inclined posture of the unmanned aerial vehicle 1110 based on a light-receiving location difference or a light-receiving time difference of the optical sensor 1113 for two or more lights. In addition, for horizontal flight, the processor 1111 may control the operation of the motor 12 to rotate in reverse in response to the determined inclined posture.

In case of transmitting control information or the like using an optical signal, the processor 1121 may determine the control information based on the light recognized by the optical sensor 1113.

The unmanned aerial vehicle 1110 according to an embodiment of the present invention may include a transmitter for transmitting a radio signal, and a receiver for receiving an uplink grant (UL grant) and a downlink grant (DL grant).

The unmanned aerial vehicle 1110 may transmit and receive various types of information through wireless communication by the transmitter, and the receiver with a station 1120, a server 200 in FIG. 3.

Meanwhile, in an environment where wireless communication performance is poor, transmission and reception of control information using light may be very useful. For example, even when attempting to land in an environment in which wireless communication is not performed smoothly, accurate location, posture, and altitude can be determined using light, and precise landing control is possible by transmitting and receiving detailed control information.

Accordingly, the processor 1121 of the station 1120 may blink the light source to correspond to a predetermined control signal according to the state of the transmitter.

In addition, the processor 1111 of the unmanned aerial vehicle 1110 may determine control information based on the light recognized by the optical sensor 1113 when the reception sensitivity of the receiver is less than a predetermined reference value.

According to an embodiment of the present invention, at least some light sources may output light in a direction inclined at a predetermined angle from a vertical direction of a landing surface. In this case, the processor 1111 may calculate the altitude by using the spacing of light sources that output light in the inclined direction and the spacing between the light receiving locations.

According to an embodiment of the present invention, some of the light sources may output light in a vertical direction of the landing surface, and some of the light sources may output light in a direction inclined at a predetermined angle from a vertical direction of the landing surface. In this case, the processor 1111 may determine the location and posture of the unmanned aerial vehicle 1110 by receiving the light output in the vertical direction, and determines the altitude by receiving the light output in the inclined direction.

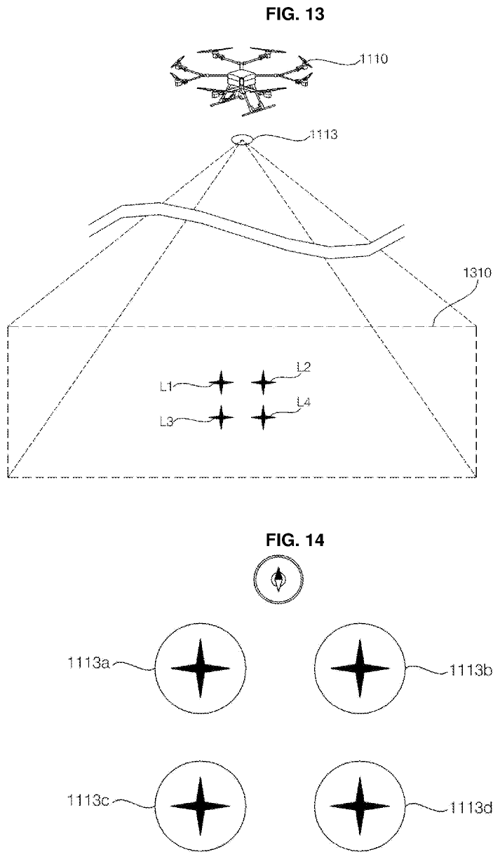

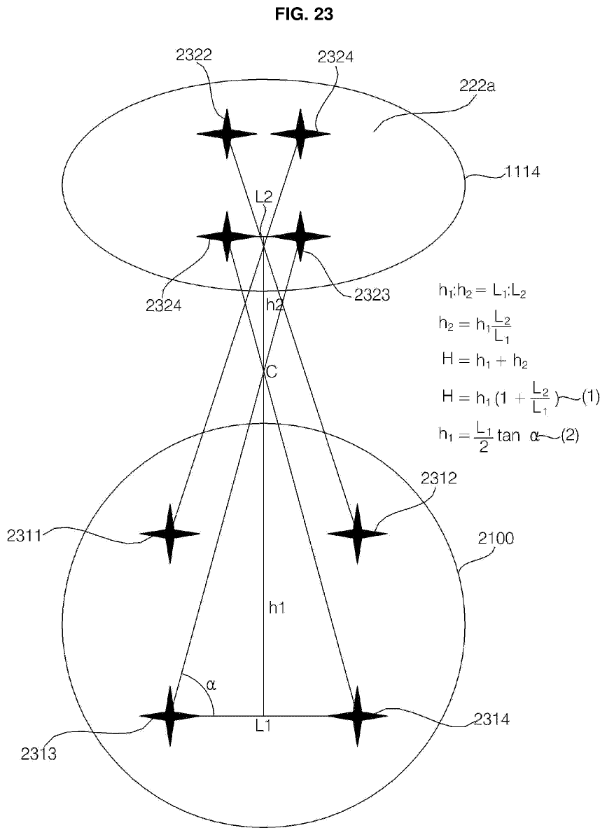

Hereinafter, the determination and control of the location and posture will be described in more detail with reference to FIGS. 13 to 22, and the determination of altitude will be described in more detail with reference to FIG. 23.

FIG. 13 is a diagram referenced illustrating optical recognition according to the embodiment of the present invention.

According to an embodiment of the present invention, the location and posture of the unmanned aerial vehicle 1110 may be determined using a pad utilizing a light source. Also, according to an embodiment of the present invention, drone control communication is possible through a modulation method of an optical signal output from a light source.

Referring to FIG. 13, light-emitting pads L1, L2, L3, and L4 including one or more light sources capable of emitting light on the landing surface 1310 of the station or the ground may be installed. Accordingly, a plurality of light sources may be disposed on the landing surface 1310 or the ground of the station. In addition, the plurality of light sources may be distinguished from each other by setting at least one of modulation information such as frequency to be different from each other. For example, the light source of light emitting pad L1 outputs an optical signal at 20 Hz, the light source of light emitting pad L2 outputs an optical signal at 40 Hz, the light source of light emitting pad L3 outputs an optical signal at 60 Hz, and The light source can output an optical signal at 80 Hz.

The optical sensor 1113 of the unmanned aerial vehicle 1110 may receive and recognize light output from light sources included in the light emitting pads L1, L2, L3, and L4.

According to an embodiment, the optical sensor 1113 may include a plurality of light reception modules, and each light reception module may detect one or more light.

FIG. 14 shows an example of an arrangement of a light reception module according to embodiments of the present invention.

Referring to FIG. 14, the optical sensor 1113 may include a plurality of light reception modules 1113a, 1113b, 1113c, and 1114d. When a light source having strong straightness is used, each of the light reception modules 1113a, 1113b, 1113c, and 1114d may be arranged to receive light output from different light sources. In this case, the number of light reception modules 1113a, 1113b, 1113c, and 1114d may preferably correspond to the number of light sources disposed within a predetermined distance. For example, when four light sources are disposed in one light emitting pad, it may be desirable to include four light receiving portions 1113a, 1113b, 1113c, and 1114d.

Meanwhile, the processor 1111 may identify the light source and/or the light emitting pads L1, L2, L3, and L4 that output the corresponding light based on the light recognized by the optical sensor 1113. In addition, the processor 1111 may utilize the identified information for location control, posture control, and the like.

Depending on the embodiment, the light emitting pads L1, L2, L3, and L4 may utilize a plurality of light sources capable of generating various modulation methods (AM, FM, PM). Location and posture information between the pad and the unmanned aerial vehicle 1110 may be extracted through this modulation method.

Using this, it is possible to control the location and posture of the unmanned aerial vehicle 1110 even at medium to high altitude.

In the case of performing the location and posture control of the unmanned aerial vehicle 1110 by recognizing image-based information through a camera, the higher the altitude, the more difficult it is to recognize the image, and there is a problem that the recognition rate decreases significantly depending on conditions such as lighting, weather, and time.

For example, when using the image recognition pattern to control the 3D location and posture of the unmanned aerial vehicle 1110, it takes additional software computation time to recognize the image pattern, and it is difficult to recognize the pattern due to blurring at a high altitude. In addition, it is difficult to recognize patterns at night and in an indoor environment without lighting.

In addition, the accuracy of GPS information indoors may be poor, and it is difficult to determine the self-shake and direction angle of the unmanned aerial vehicle 1110.

However, according to embodiments of the present invention, it is possible to control the three-dimensional location/posture of the unmanned aerial vehicle 1110 even at medium to high altitudes where it is difficult to recognize a pattern using light. Accordingly, it is possible to reduce the amount of computation required for pattern recognition, it is possible to identify the station and the landing surface even at high altitude, and there is an advantage that landing and precise control are possible even at night and in an environment without lighting.

The unmanned aerial vehicle 1110 may include an optical sensor 1113 to receive light output from a light source on the landing surface, and identify a light source that outputs the received light as modulation information of the received light. The x and y coordinates can be determined with the identified information. In addition, the unmanned aerial vehicle 1110 can determine the posture of the unmanned aerial vehicle 1110 based on the identified information. According to an embodiment of the present invention, the determined location(/posture) information may be used for location (/ posture) control. In particular, it is possible to control the location(/ posture) even in flight in an indoor structure where GPS signal reception is difficult, at night, or in a flight in an environment where image recognition is difficult due to no lighting.

A geometric combination of light source arrangements, using homogeneous light sources, is essential for posture and location control. For example, three or more light sources are required to recognize geometric combinations such as triangulation. Also, in the case of symmetric geometric combinations, there is ambiguity in the perception of the unmanned aerial vehicle's yaw. In addition, when a small number (1 or 2) of light enters the light receiving part of the optical sensor, there is a disadvantage that it is impossible to control the posture and location of the unmanned aerial vehicle.

However, according to embodiments of the present invention, individual light/light sources can be identified from other light/light sources by varying modulation information such as frequencies of lights output from light sources. In addition, the unmanned aerial vehicle 1110 may calculate its own location using coordinate information of the identified light source.

In addition, according to an embodiment of the present invention, it is possible to control and communicate the unmanned aerial vehicle 1110 by using a modulation technique on an optical signal. Accordingly, it is possible to exchange information between the unmanned aerial vehicle 1110—the station 1120 and control the unmanned aerial vehicle 1110.

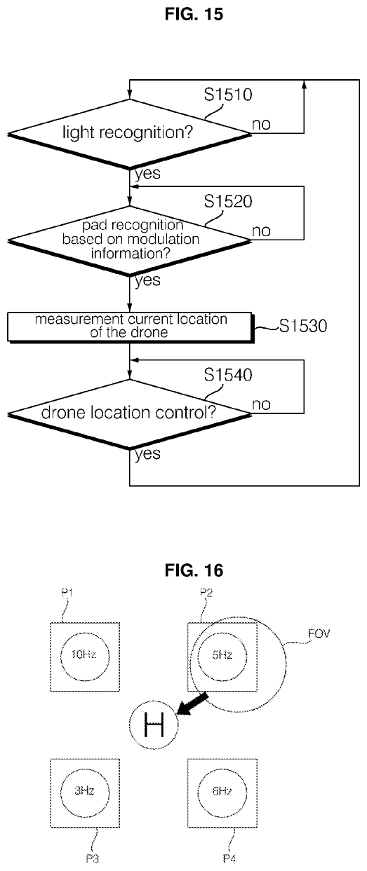

FIG. 15 is a flowchart showing a location control method according to the embodiment of the present invention.

FIG. 16 is a diagram referenced illustrating location control method according to the embodiment of the present invention.

FIGS. 15 and 16, light emitting pads P1, P2, P3, and P4 including at least one light source may be disposed on the landing surface or the ground of the station 1120. In this case, the light output from the light source included in the light emitting pads P1, P2, P3, and P4 may be classified by setting different modulation information such as frequency. For example, the light source of light emitting pad P1 outputs an optical signal at a frequency of 10 Hz, the light source of light emitting pad P2 outputs an optical signal at a frequency of 5 Hz, and the light source of light emitting pad P3 outputs an optical signal at a frequency of 3 Hz, and the light source of the light emitting pad P4 can output an optical signal at a frequency of 6 Hz.

The unmanned aerial vehicle 1110 can recognize at least some of the light output upwards from the light sources through the optical sensor 1113 during flight (S1510), and the detection information of the optical sensor 1113 may be transmitted to the processor 1111.

The processor 1111 may identify a light source and/or a light emitting pad that outputs light recognized by the optical sensor 1113 based on modulation information among the sensing information of the optical sensor 1113 (S1520).

FIG. 15 illustrates a case where the light emitting pad P2 is located within the field of view (FOV) of the optical sensor 1130. According to the example of FIG. 15, the optical sensor 1130 may recognize an optical signal having a frequency of 5 Hz (S1510), and the processor 1111 may recognize the optical signal as modulation information (frequency of 5 Hz) and determine that it is output from the light-emitting pad P2(S1520).

The processor 1111 may measure the current location of the drone 1110 based on the recognized location information of the light emitting pad P2 (S1530).

In addition, the processor 1111 may control the location of the drone 1110 based on the measured current location information (S1540).

For example, as illustrated in FIG. 15, the processor 1111 may control the operation of the motor 12 so that the drone 1110 moves to the landing point H based on the location information of the light emitting pad P2.

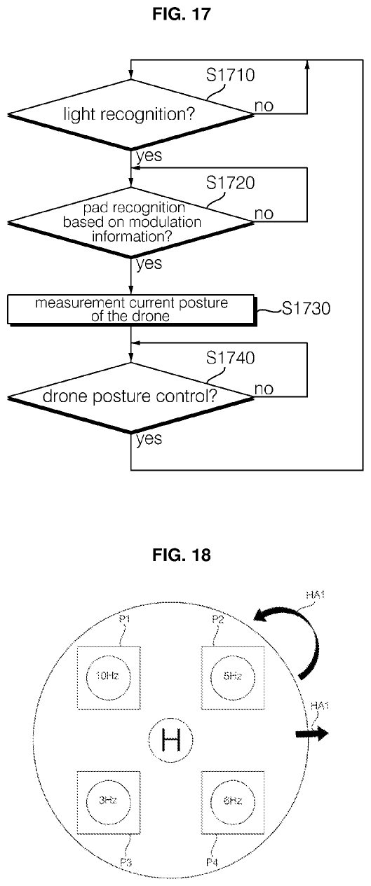

FIG. 17 is a flowchart showing a location control method according to the embodiment of the present invention.

FIG. 18 is a diagram referenced illustrating a location control method according to the embodiment of the present invention.

FIGS. 17 and 18, light emitting pads P1, P2, P3, and P4 including at least one light source may be disposed on the landing surface or the ground of the station 1120. In this case, the light output from the light source included in the light emitting pads P1, P2, P3, and P4 may be classified by setting different modulation information such as frequency. For example, the light source of light emitting pad P1 outputs an optical signal at a frequency of 10 Hz, the light source of light emitting pad P2 outputs an optical signal at a frequency of 5 Hz, and the light source of light emitting pad P3 outputs an optical signal at a frequency of 3 Hz, and, the light source of the light emitting pad P4 can output an optical signal at a frequency of 6 Hz.

The unmanned aerial vehicle 1110 can recognize at least some of the light output upward from the light sources through the optical sensor 1113 during flight (S1710), and the detection information of the optical sensor 1113 may be transmitted to the processor 1111.

The processor 1111 may identify a light source and/or a light emitting pad that outputs light recognized by the optical sensor 1113 through modulation information among the sensing information of the optical sensor 1113 (S1720).

FIG. 17 illustrates a case where four light emitting pads P1, P2, P3, and P4 are located within a field of view (FOV) of the optical sensor 1130. According to the example of FIG. 17, the optical sensor 1130 can recognize optical signals having frequencies of 10, 5, 3, and 6 Hz, respectively (S1710), and the processor 1111 may determine light emitting pads P1, P2, P3, and P4 which output optical signals recognized as modulation information.

The processor 1111 may measure the current posture of the drone 1110 based on the recognized location information of the light emitting pads P1, P2, P3, and P4 (S1730). For example, the processor 1111 may determine the relative locational relationship of the light emitting pads P1, P2, P3, P4 from the location information of the light emitting pads P1, P2, P3, P4, and identify the direction angle of the current drone 1110 from the relationship between the direction and location of the light/light emitting pad information.

Also, the processor 1111 may perform a posture control of the drone 1110 based on the measured current posture information (S1740).

For example, as in the example of FIG. 18, the processor 1111 identifies that the drone 1110 has a direction angle HA1 away from the landing point H beyond the light emitting pad P2, and the processor 1111 may control the operation of the motor 12 so as to rotate the drone 1110 at the direction angle HA2 toward the landing point H.

According to an embodiment of the present invention, it is possible to check the heading direction of the drone, and to identify each light source through modulation information. In addition, it is possible to control the drone through the modulation of the optical signal, and it can be used as a backup communication means when flying on a mission at a high altitude or in a poor communication environment. In addition, it is possible to control the location of the drone even with a single beam.

According to an embodiment of the present invention, it is also possible to calculate the height of the Z-axis altitude by using light with strong straightness that is output obliquely. For example, a tilted laser beam can be used as a light source to calculate the Z-axis altitude height. Altitude calculation will be described later with reference to FIG. 23.

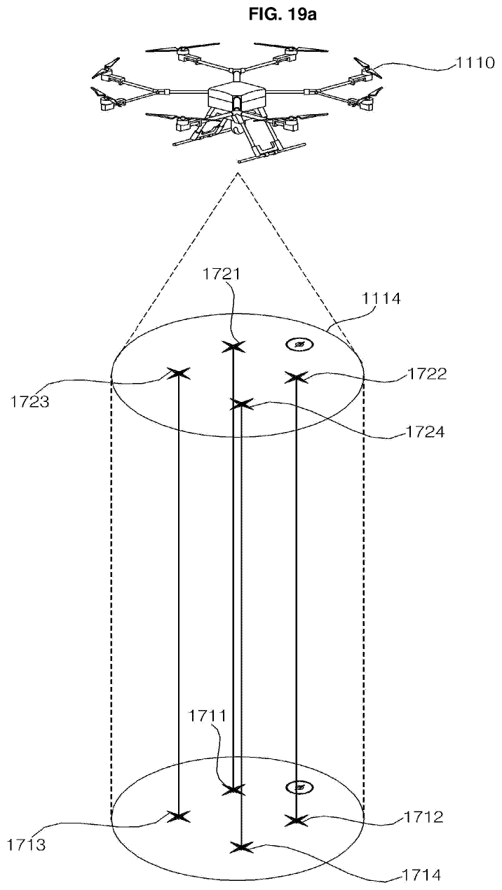

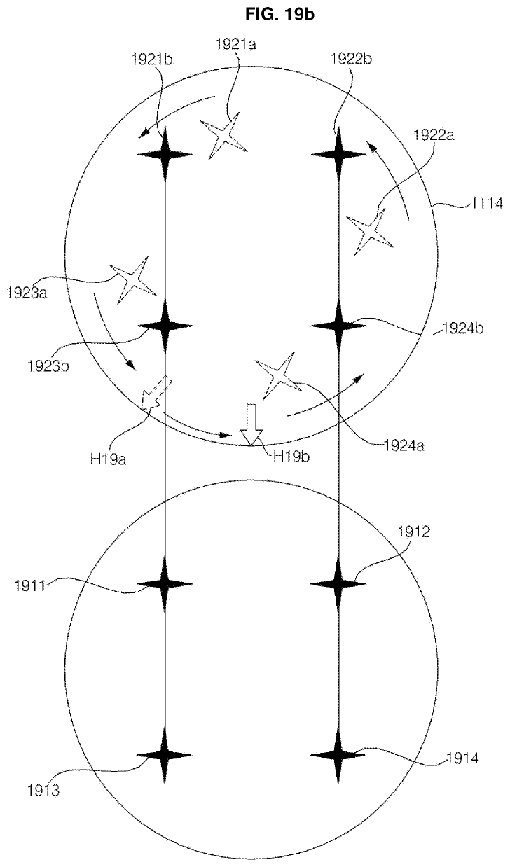

FIGS. 19a and 19b are diagrams referenced illustrating a location control method according to the embodiment of the present invention.

Referring to FIG. 19A, the drone 1110 may recognize the lights 1721, 1722, 1723, and 1724 output upward from light sources 1711, 1712, 1713, and 1714 for which different modulation information is set through the light reception module 1114 of the optical sensor 1113. Here, the light sources 1711, 1712, 1713, and 1714 may output light in a vertical direction or may output light inclined at a predetermined angle in the vertical direction.

Meanwhile, the processor 1111 may identify that light sources 1711, 1712, 1713, 1714 outputs lights 1721, 1722, 1723, 1724 according to modulation information (e.g., frequency information) of the recognized lights 1721, 1722, 1723, 1724.

Also, the processor 1111 may determine the location of the drone 1110 based on the location information of the identified light sources 1711, 1712, 1713, and 1714.

In addition, the processor 1111 may also check the posture of the drone 1110 (horizontal level, the heading direction of the drone (yaw)).

In addition, the processor 1111 may perform posture control of adjusting a heading direction or the like after the posture of the identified drone 1110.

Referring to FIG. 19B, the drone 1110 may recognize lights 1921a, 1922a, 1923a, and 1924a output upward from light sources 1911, 1912, 1913, and 1914 for which different modulation information is set through the light reception module 1114 of the optical sensor 1113.

The processor 1111 may identify that light sources 1911a, 1912a, 1913a, and 1914a outputs lights 1921a, 1922a, 1923a, and 1924a according to modulation information (e.g., frequency information) of the recognized lights 1921a, 1922a, 1923a, and 1924a.

Also, the processor 1111 may determine the location of the drone 1110 based on the location information of the identified light sources 1911, 1912, 1913, and 1914.

In addition, the processor 1111 may determine the arrangement type of the light sources 1911, 1912, 1913, 1914 using the location information of the light sources 1911, 1912, 1913, 1914, and check the posture of the drone 1110 (horizontal level, the heading direction of the drone (yaw)) using this arrangement type.

For example, in the case of using a laser light source, the processor 1111 may also determine the location of the laser (desired laser location) when the heading direction matches according to the arrangement type of each laser.

Accordingly, the drone 1110 may be rotated to match the laser location in the current heading direction H19a to fix it in a desired heading direction H19b.

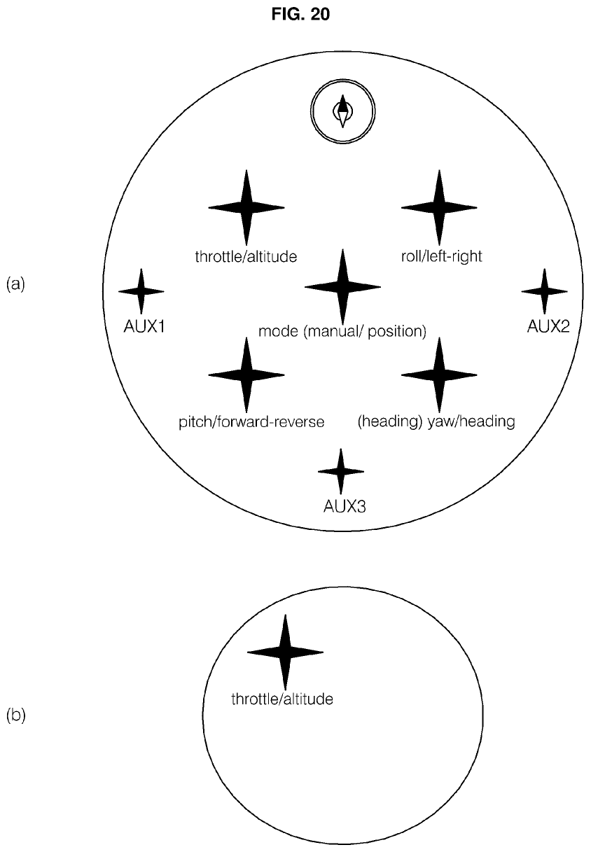

FIG. 20 is a diagram referenced illustrating an aerial control system according to the embodiment of the present invention.

When using the same type of light source, the light source may be geometrically arranged on a plane and used for posture and location control. For example, the lasers are arranged in a triangle, and the lengths and angles of three sides of a triangle in which virtual lines between the lasers are three sides may be used.

However, since the posture and location cannot be determined unless the entire geometric combination is identified, relative location/posture estimation cannot be performed during single laser recognition.

In addition, even when all lasers are recognized, only predetermined information can be estimated, but specific control information cannot be transmitted.

Referring to FIG. 20(a), the drone 1110 according to an embodiment of the present invention may recognize a plurality of lasers. In addition, the processor 1111 may distinguish each laser using modulation information such as frequency. Accordingly, the processor 1111 may more accurately determine the current location and posture by using location information of a plurality of recognized lasers.

According to an embodiment of the present invention, it is possible to control a drone through modulation. For example, the light signal of each distinguishable light source may include control signals such as mode (manual/position), throttle/altitude adjustment, roll/left-right movement, pitch/forward-reverse, yaw/heading. In particular, this control is very useful for indoor vertical flight of drones. While indoor vertical flight has a limited range of movement on the plane, the range of movement in the vertical direction is large. Therefore, the recognition rate of light compared to the image is very high even at high altitude, and it performs a desirable operation at a location when recognizing a light source placed in a specific location. It can be included as a control signal. Accordingly, it is possible to precisely control the drone 1110 without performing separate communication.

Referring to FIG. 20(b), the drone 1110 according to an embodiment of the present invention may recognize a single laser.

Even in this case, the processor 1111 may identify the laser by using modulation information such as frequency, and may use the location information of the laser. Accordingly, even if only one laser is identified, the relative location/posture may be estimated. In addition, it is possible to control the location of the drone even with a single beam.

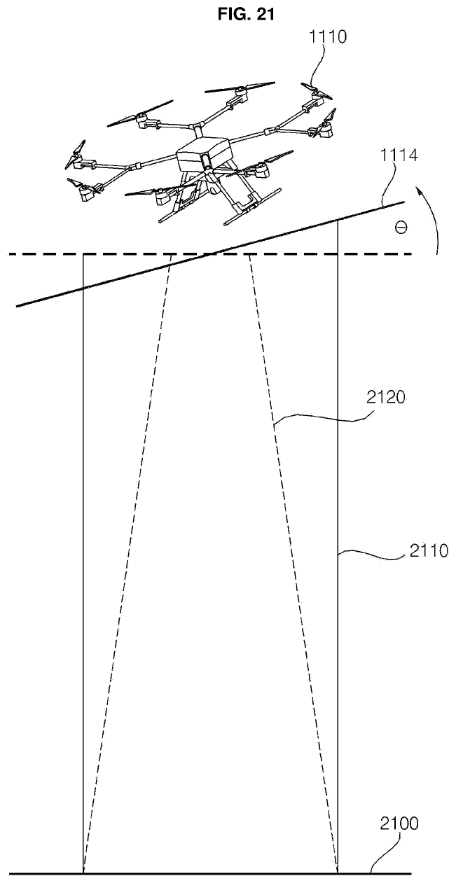

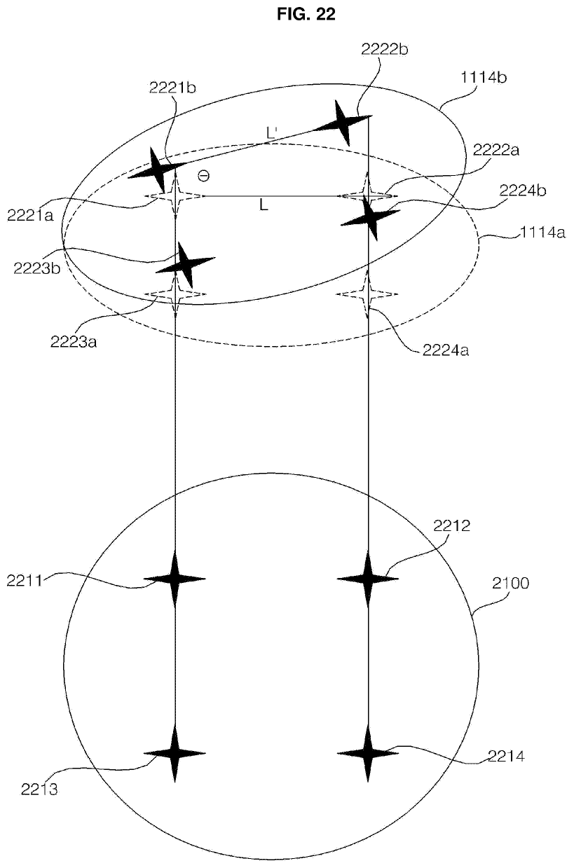

FIGS. 21 and 22 are diagrams referenced illustrating location control method according to the embodiment of the present invention.

Referring to FIGS. 21 and 22, the drone 1110 needs to be adjusted for horizontal flight while the posture is inclined at a predetermined angle θ.

FIGS. 21 and 22, light sources 2211, 2212, 2213, 2214 disposed on the ground 2100 or the landing surface of the station 1120 output light in a vertical direction (2110) or output at an inclined angle at vertical direction (2120).

According to an embodiment of the present invention, light output from the ground 2100 or the landing surface of the station 1120 in an upward direction may be received by the light reception module 1114 to be used configured to determine and controlling a location/posture. FIG. 22 illustrates a case 2110 in which light is output in a vertical direction.

The drone 1110 may recognize the light output from the light sources 2211, 2212, 2213, and 2214 to which different modulation information is set through the light reception module 1114 of the optical sensor 1113.

The processor 1111 may determine the inclined posture of the drone 1110 based on a light-receiving location difference or a light-receiving time difference of the optical sensor 1113 for two or more lights.

For example, the inclined posture 8 can be determined by substituting L and L′ determined at the light-receiving locations 2221a, 2222a, 2223a, 2224a in the first light-receiving state 1114a corresponding to the plurality of light sources 2211, 2212, 2213, 2214, and the light-receiving locations 2221b, 2222b, 2223b, and 2224b in the second light-receiving state 1114b into the following trigonometric function.

$$θ = {cos}^{- 1} \frac{L}{{L}^{′}}$$

In this way, the drone's posture (roll, pitch) may be measured using a trigonometric function, and precise horizontal control of the drone may be performed using the measured drone's posture.

In addition, even if the tilting laser 2120 is used, the tilted posture 8 can be determined in the same manner and precise horizontal control of the drone may be performed.

FIG. 23 is a diagram referenced illustrating an altitude determination method according to the embodiment of the present invention.

Referring to FIG. 23, light sources 2311, 2312, 2313, and 2314 disposed on the ground 2100 or the landing surface of the station 1120 may output light inclined at a predetermined angle (90 degrees−α) in the vertical direction. In addition, the arranged light sources 2311, 2312, 2313, and 2314 may set at least one of the modulation information set differently.

The drone 1110 may recognize lights 2321, 2322, 2323, 2324 upwardly output from the light sources 2311, 2312, 2313, 2314 which different modulation information is set through the light reception module 1114 of the optical sensor 1113.

The processor 1111 may identify the light sources 2311, 2312, 2313, 2314 that outputs each of the lights 2321, 2322, 2323, 2324 according to the modulation information (e.g., frequency information).

Also, the processor 1111 may determine the location of the drone 1110 based on the location information of the identified light sources 2311, 2312, 2313, and 2314.

In addition, the processor 1111 may determine the arrangement type of the light sources 2311, 2312, 2313, 2314 using the location information of the light sources 2311, 2312, 2313, 2314, and check the posture of the drone 1110 (horizontal level, the heading direction of the drone (yaw)) using this arrangement type.

According to an embodiment of the present invention, it is also possible to calculate the height of the Z-axis altitude by using light with strong straightness that is output obliquely. For example, a laser beam whose output direction is tilted based on the ground or vertical direction is used as the light sources 2311, 2312, 2313, 2314, it is possible to calculate the height of the Z-axis altitude/height(H).

The Z-axis altitude/height (H) is the sum of the first height (h1) which is the height of the intersection point (C) where lights cross, and the second height (h2) which is the distance from the intersection point (C) to the drone 1110. In this case. the height (h1) of the intersection point (C) is calculated by substituting the angle at which the light is inclined (a) with respect to the ground 2100 or the landing surface and the distance L1 between the light source into the trigonometric function of equation (2).

Further, the distance L1 between the light sources and the distance L2 of the corresponding lights on the light reception module 1114 have a proportional relationship with the first height h1 and the second height h2.

Accordingly, as shown in FIG. 23, the calculation formula of the Z-axis altitude/height (H) may be summarized by Equation (1), and the processor 1111 may finally calculate the Z-axis altitude/height(H), since the distance L2, the distance L1 between the light sources and the corresponding light on the light reception module 1114, the angle α be known.

The calculation formula described with reference to FIG. 23 is exemplary, and other formulas may be used.

When only a straight laser that outputs light in the vertical direction is used, information on the distance cannot be obtained, but the present embodiment has a feature that information on the distance can be obtained by tilting the laser.

Accordingly, at least some of the plurality of light sources may output light in a direction inclined at a predetermined angle from the landing surface or the vertical direction of the ground, and the height of the drone may be calculated using this.

In addition, some of the plurality of light sources output light in a direction perpendicular to the landing surface or the ground, and some of the plurality of light sources output light in a direction inclined at a predetermined angle from the landing surface or in the vertical direction of the ground.

If the light output to go straight in the vertical direction is used, since there is no calculation process related to the angle, it is possible to determine the location and posture more quickly. However, the height cannot be calculated.

Therefore, the light output directions can be used in combination. That is, location and posture control may be performed more precisely and conveniently using light output in the vertical direction, and altitude may be accurately calculated using light output in a direction inclined at a predetermined angle from the vertical direction.

According to an embodiment of the present invention, it is possible to measure and control a more accurate posture and distance through a combination of an inclined laser and a vertical straight laser.

General device to which the present invention is applicable

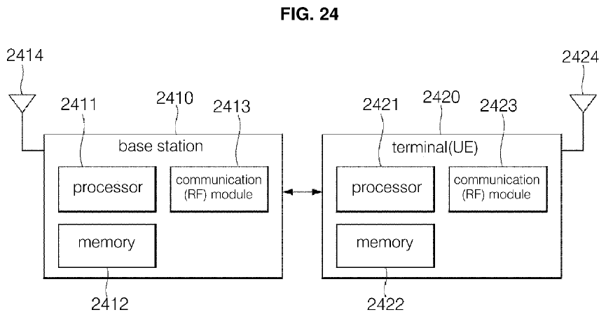

FIG. 24 shows a block diagram of a wireless communication device according to an embodiment of the present invention.

Referring to FIG. 24, a wireless communication system includes a base station (or network) 2410 and a terminal 2420.

Here, the terminal may be a UE, a UAV, an unmanned aerial robot, a wireless aerial robot, or the like.

The base station 2410 includes a processor 2411, a memory 2412, and a communication module 2413.

The processor executes the functions, processes, and/or methods described in FIGS. 1 to 23. Layers of wired/wireless interface protocol may be implemented by the processor 2411. The memory 2412 is connected to the processor 2411 and stores various information for driving the processor 2411. The communication module 2413 is connected to the processor 2411 to transmit and/or receive a wired/wireless signal.

The communication module 2413 may include a radio frequency (RF) unit for transmitting/receiving a wireless signal.

The terminal 2420 includes a processor 2421, a memory 2422, and a communication module (or RF unit) 2423. The processor 2421 executes the functions, processes, and/or methods described in FIGS. 1 to 23. Layers of wireless interface protocol may be implemented by the processor 2421. The memory 2422 is connected to the processor 2421 and stores various information for driving the processor 2421. The communication module 2423 is connected to the processor 2421 to transmit and/or receive a wireless signal.

The memories 2412 and 2422 may be located inside or outside the processors 2411 and 2421, and may be connected to the processors 2411 and 2421 by well-known various means.

In addition, the base station 2410 and/or the terminal 2120 may have a single antenna or multiple antennas.

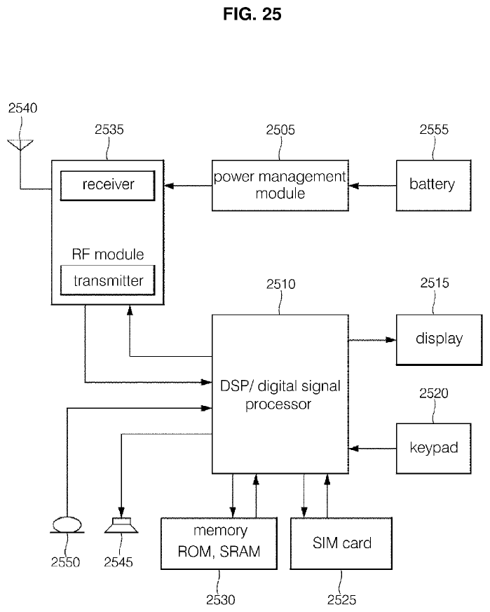

FIG. 25 is a block diagram of a communication device according to an embodiment of the present invention.

In particular, FIG. 25 shows the terminal of FIG. 24 in more detail.

Referring to FIG. 25, the terminal may be configured to include a processor (or a digital signal processor (DSP)) 2510, an RF module (or an RF unit) 2535, or a power management module 2205, an antenna 2540, a battery 2555, a display 2515, a keypad 2520, a memory 2530, a subscriber identification module (SIM) card 2525 (this configuration is optional), a speaker 2545, and a microphone 2550. In addition, the terminal may include a single antenna or multiple antennas.

The processor 2510 executes the functions, processes, and/or methods described in FIGS. 1 to 24. Layers of wireless interface protocol may be implemented by the processor 2510.

The memory 2530 is connected to the processor 2510 and stores information related to an operation of the processor 2510. The memory 2530 may be located inside or outside the processor 2510, and may be connected to the processor 2510 by well-known various means.

For example, the user inputs command information such as a telephone number by pressing (or touching) a button on the keypad 2520 or by voice activation using the microphone 2550. The processor 2510 executes and processes proper functions such as receiving the command information or dialing a telephone number. Operational data may be extracted from the SIM card 2525 or the memory 2530. In addition, the processor 2510 may display command information or driving information on the display 2515 for the user to recognize and for convenience.

The RF module 2535 is connected to the processor 2510 to transmit and/or receive an RF signal. For example, the processor 2510 transmits command information to the RF module 2535 to transmit a wireless signal constituting voice communication data to initiate communication. The RF module 2535 includes a receiver and a transmitter for receiving and transmitting a wireless signal. The antenna 2540 functions to transmit and receive a wireless signal. When the wireless signal is received, the RF module 2535 may transmit the signal and convert the signal to a baseband for processing by the processor 2510. The processed signal may be converted into audible or readable information output through the speaker 2545.

The embodiment according to the present invention may be implemented by various means, for example, hardware, firmware, software, or a combination thereof. In the case of implementation by hardware, an embodiment of the present invention includes one or more application specific integrated circuits (ASICs), digital signal processors (DSPs), digital signal processing devices (DSPDs), programmable logic devices (PLDs), and FPGAs (field programmable gate arrays), processors, controllers, microcontrollers, microprocessors, etc.

In the case of implementation by firmware or software, an embodiment of the present invention may be implemented in the form of a module, procedure, or function that performs the functions or operations described above. The software code can be stored in a memory and driven by a processor. The memory may be located inside or outside the processor, and may exchange data with the processor through various known means.

It will be appreciated that in the specification, each block of the process flow diagrams and combinations of the flow chart diagrams may be executed by computer program instructions. Since these computer program instructions can be mounted on the processor of a general purpose computer, special purpose computer or other programmable data processing equipment, the instructions executed by the processor of the computer or other programmable data processing equipment are described in the flowchart block(s). It creates a means to perform functions. These computer program instructions can also be stored in computer-usable or computer-readable memory that can be directed to a computer or other programmable data processing equipment to implement a function in a particular way, so that the computer-usable or computer-readable memory It is also possible to produce an article of manufacture containing instruction means for performing the functions described in the flowchart block(s). Computer program instructions can also be mounted on a computer or other programmable data processing equipment, so a series of operating steps are performed on a computer or other programmable data processing equipment to create a computer-executable process to create a computer or other programmable data processing equipment. It is also possible for instructions to perform processing equipment to provide steps for executing the functions described in the flowchart block(s).

In addition, each block may represent a module, segment, or part of code that contains one or more executable instructions for executing the specified logical function(s). In addition, it should be noted that in some alternative execution examples, functions mentioned in blocks may occur out of order. For example, two blocks shown in succession may in fact be executed substantially simultaneously, or the blocks may sometimes be executed in reverse order depending on the corresponding function.

As is apparent from the above description, according to at least one of the embodiments of the present invention, the location of the unmanned aerial vehicle is accurately determined using light, and precise control is possible.

In addition, according to at least one of the embodiments of the present invention, the altitude of the unmanned aerial vehicle is accurately determined using light, and precise control is possible.

In addition, according to at least one of the embodiments of the present invention, it has the advantage of being able to accurately determine the location, posture, and altitude of the unmanned aerial vehicle even in environments where high altitude, nighttime, and external lighting is difficult, and precise control.

In addition, according to at least one of the embodiments of the present invention, it is possible to control the posture and landing of the unmanned aerial vehicle even when the communication situation is poor.

Various other effects of the present invention are directly or suggestively disclosed in the above detailed description of the invention. It is an object of the present specification to provide a method and apparatus capable of determining the location of an unmanned aerial vehicle using light in an aerial control system for an unmanned aerial vehicle.

It is another object of the present specification to provide a method and apparatus capable of determining the altitude of an unmanned aerial vehicle using light in an aerial control system for an unmanned aerial vehicle.

It is another object of the present specification to provide an unmanned aerial vehicle and a station device capable of accurately determining the location of an unmanned aerial vehicle and precisely controlling the posture.

In order to accomplish the above and other objects, the unmanned aerial vehicle according to an embodiment disclosed in the present specification includes: a main body; at least one motor provided in the main body; at least one propeller connected to each of the at least one motor; an optical sensor provided in the main body and recognizing at least some of lights output from light sources of a station; and a processor configured to determine a current location based on the light recognized by the optical sensor, wherein the light sources of the station are set differently in at least one modulation information of a frequency, a size, and a length of the output lights, and the processor identifies a light source that outputs light recognized by the optical sensor through the differently set modulation information, and determine the current location based on location information of the identified light source.

In addition, the processor may control the motor to move the unmanned aerial vehicle to the landing point of the station based on the determined current location, and a direction angle(heading angle) of the unmanned aerial vehicle based on the location information of the identified light source.

In this case, the processor may control the heading angle by rotating the unmanned aerial vehicle so that the light reception location of the optical sensor coincides with a reference location set to correspond to the arrangement location of the light sources.

In addition, the processor may determine an inclined posture of the unmanned aerial vehicle based on a difference in a light reception location or a light reception time difference of the optical sensor for two or more lights.

In addition, the processor may determine control information based on light recognized by the optical sensor.

An unmanned aerial vehicle according to an embodiment of the present specification further includes: a transmitter for transmitting a radio signal; and, a receiver for receiving an uplink grant (UL grant) and a downlink grant (DL grant); wherein, the processor, when a reception sensitivity of the receiver is less than a predetermined reference value, may determine control information based on the light recognized in the optical sensor.

Meanwhile, the station may include a plurality of light emitting pads, and each of the plurality of light emitting pads may include one or more light sources having the modulation information set differently from each other.

In addition, the optical sensor may include a plurality of light reception modules.

In addition, at least some of the light sources may output light in a direction inclined at a predetermined angle from a vertical direction of the landing surface. In this case, the processor may determine an altitude using the spacing of light sources outputting light in the inclined direction and the spacing between light receiving locations.

In addition, some of the light sources may output light in a vertical direction of the landing surface, and some of the light sources may output light in a direction inclined at a predetermined angle from a vertical direction of the landing surface. In this case, the processor may determine the location and posture of the unmanned aerial vehicle by receiving the light output in the vertical direction and determine the altitude by receiving the light output in the inclined direction.

In order to accomplish the above and other objects, the station according to an embodiment disclosed in the present specification includes a transmitter and a receiver for transmitting and receiving radio signals; a plurality of light sources in which at least one modulation information of a frequency, a size, and a length of the output light is set differently from each other; and a processor that controls flickering of the light sources.

In addition, the processor may flicker the light sources to correspond to a predetermined control signal. In this case, the processor may flicker the light sources to correspond to a predetermined control signal according to the state of the transmitter.

In order to accomplish the above and other objects, the station according to an embodiment disclosed in the present specification may include a plurality of light emitting pads, and each of the plurality of light emitting pads may include one or more light sources having the modulation information set differently from each other.

In addition, the plurality of light sources may be laser light sources.

In addition, at least some of the plurality of light sources may output light in a direction inclined at a predetermined angle from a vertical direction of the landing surface.

In addition, some of the plurality of light sources may output light in a vertical direction of the landing surface, and some of the plurality of light sources may output light in a direction inclined at a predetermined angle from a vertical direction of the landing surface.

It will be apparent that, although the preferred embodiments have been shown and described above, the present invention is not limited to the above-described specific embodiments, and various modifications and variations can be made by those skilled in the art without departing from the gist of the appended claims. Thus, it is intended that the modifications and variations should not be understood independently of the technical spirit or prospect of the present invention.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerial vehicle comprising:
a main body;
at least one motor;
at least one propeller coupled to each of the at least one motor;
an optical sensor provided at the main body and configured to recognize lights output from a plurality of light sources at a station; and
a processor configured to determine a current location of the aerial vehicle based on the light recognized by the optical sensor;
wherein each of the light sources at the station to provide a different output light based on set modulation information, each of the light sources to have differently set modulation information of at least one of a frequency, a size, or a length of the corresponding output light, and
the processor is configured to:
identify a light source that outputs the light recognized by the optical sensor based on the differently set modulation information, and
determine the current location of the aerial vehicle based on location information of the identified light source.

2. The aerial vehicle according to claim 1, wherein the processor controls the motor to move the aerial vehicle to a landing point at the station based on the determined current location.

3. The aerial vehicle according to claim 1, wherein the processor controls a heading angle of the aerial vehicle based on the location information of the identified light source.

4. The aerial vehicle according to claim 3, wherein the processor controls movement of the aerial vehicle such that a light reception location of the optical sensor coincides with a reference location o corresponding to an arrangement location of the identified light source.

5. The aerial vehicle according to claim 1, wherein the processor determines an inclined posture of the aerial vehicle based on a difference in a light reception location or a light reception time difference of the optical sensor for at least two of the light sources.

6. The aerial vehicle according to claim 1, wherein the processor determines control information based on the light recognized by the optical sensor.

7. The aerial vehicle according to claim 1, further comprising:
a transmitter for transmitting a radio signal; and
a receiver for receiving an uplink grant (UL grant) and a downlink grant (DL grant);
wherein when a reception sensitivity of the receiver is less than a predetermined reference value, the processor is to determine control information based on the light recognized by the optical sensor.

8. The aerial vehicle according to claim 1, wherein the station includes a plurality of light emitting pads, and each of the plurality of light emitting pads includes one or more of the light sources having the differently set modulation information.

9. The aerial vehicle according to claim 1, wherein the optical sensor includes a plurality of light reception modules.

10. The aerial vehicle according to claim 1, wherein at least one of the light sources outputs light in a direction inclined at a predetermined angle from a vertical direction of a surface at the station.

11. The aerial vehicle according to claim 10, wherein the processor determines an altitude of the aerial vehicle based on spacing of the light sources outputting light in the inclined direction and the spacing between light receiving locations.

12. The aerial vehicle according to claim 1, wherein at least one of the light sources outputs light in a vertical direction of a surface at the station, and at least another one of the light sources outputs light in a direction inclined at a predetermined angle from the vertical direction of the surface.

13. The aerial vehicle according to claim 12, wherein the processor determines location and posture of the aerial vehicle based on the light output in the vertical direction and determines altitude of the aerial vehicle based on the light output in the inclined direction

14. A station comprising:
a transmitter and a receiver for transmitting and receiving radio signals;
a plurality of light sources on a surface, each of the light sources to provide a separate output light based on set modulation information, each of the light sources having differently set modulation information of at least one of a frequency, a size, or a length of the corresponding output light; and
a processor configured to control flickering of the light sources.

15. The station according to claim 14, wherein at least one of the light sources outputs light in a direction inclined at a predetermined angle from a vertical direction of the surface.

16. The station according to claim 14, wherein at least one of the light sources outputs light in a vertical direction of the surface, and at least one of the light sources outputs light in a direction inclined at a predetermined angle from a vertical direction of the surface.

17. The station according to claim 14, wherein the processor flickers the light sources to correspond to a predetermined control signal.

18. The station according to claim 14, wherein the processor flickers the light sources to correspond to a predetermined control signal according to state of the transmitter.

19. The station according to claim 14, further comprising:
a plurality of light emitting pads, and
each of the plurality of light emitting pads includes one or more of the light sources having the differently set modulation information.

20. The station according to claim 14, wherein each of the plurality of light sources is a separate laser light source.
